(19) United States
(12) Patent Application Publication
(10) Pub. No.: US 2024/0326272 A1
(43) Pub. Date: Oct. 3, 2024

(54) OUTER BLADE BLOCK AND ELECTRIC SHAVER

(71) Applicant: Panasonic Intellectual Property Management Co., Ltd., Osaka (JP)

(72) Inventor: HIROAKI SHIMIZU, Shiga (JP)

(21) Appl. No.: 18/595,530

(22) Filed: Mar. 5, 2024

(30) Foreign Application Priority Data
Mar. 28, 2023 (JP) 2023-050961

(51) Int. Cl. B26B 19/38; B26B 19/06

(52) U.S. Cl. CPC B26B 19/388; B26B 19/3846; B26B 19/06

(57) ABSTRACT

The present disclosure provides an outer blade block and an electric shaver configured to press an outer blade against a skin with a more appropriate pressing force. The electric shaver according to the present disclosure includes an outer blade and a load adjustment mechanism configured to adjust a load applied to the outer blade. The load adjustment mechanism includes a float mechanism that includes a biasing member that biases the outer blade toward one side in one direction, and a reception part that receives the biasing member, and floats an outer blade piece in one direction. The load adjustment mechanism includes a movable mechanism configured to move the reception part in one direction, and a sensor that detects a load applied to the outer blade. The load adjustment mechanism further includes a controller that controls a movement amount of the reception part in one direction based on the load applied to the outer blade detected by the sensor.

### BACKGROUND

### 1. Technical Field

The present disclosure relates to an outer blade block and an electric shaver.

### 2. Description of the Related Art

Conventionally, as an outer blade block and an electric shaver, as shown in PTL 1, there has been known an outer blade block and an electric shaver in which an outer blade is held movably up and down in a state where an upward biasing force is applied by a spring, so that the outer blade can be pressed against a skin with a more appropriate pressing force.

### CITATION LIST

### Patent Literature

PTL 1: Unexamined Japanese Patent Publication No. 2010-099493

### SUMMARY

In the conventional technique described above, the outer blade can be pressed against the skin with an appropriate pressing force, but it is preferable that the outer blade can be pressed against the skin with a more appropriate pressing force.

It is therefore an object of the present disclosure to provide an outer blade block and an electric shaver configured to press an outer blade against a skin with a more appropriate pressing force.

An electric shaver according to one aspect of the present disclosure includes: an outer blade; and a load adjustment mechanism configured to adjust a load applied to the outer blade, in which the load adjustment mechanism includes: a float mechanism that includes a biasing member that biases the outer blade toward one side in one direction, and a reception part that receives the biasing member, and floats the outer blade in the one direction; a movable mechanism configured to move the reception part in the one direction; a sensor that detects the load applied to the outer blade; and a controller that controls a movement amount of the reception part in the one direction based on the load applied to the outer blade detected by the sensor.

An outer blade block according to an aspect of the present disclosure is an outer blade block usable in an electric shaver. The outer blade block includes: the outer blade; and the holding member detachably attached to a shaver body while holding the outer blade, in which the load applied to the outer blade is configured to be adjusted by the load adjustment mechanism when the holding member is attached to the shaver body while the outer blade is held.

According to the present disclosure, it is possible to obtain an outer blade block and an electric shaver configured to press an outer blade against a skin with a more appropriate pressing force.

### BRIEF DESCRIPTION OF THE DRAWINGS

FIG. 1 is a front view schematically illustrating an example of an electric shaver according to an exemplary embodiment;

FIG. 2 is a front view schematically illustrating an example of an outer blade block included in the electric shaver according to the exemplary embodiment;

FIG. 3 is a front view schematically illustrating an example of a load adjustment mechanism and a second load adjustment mechanism according to the exemplary embodiment;

FIG. 4 is a flowchart illustrating a first control method as a general example of a method of controlling an electric shaver according to the exemplary embodiment;

FIG. 5 is a flowchart illustrating a control method using the load adjustment mechanism according to the exemplary embodiment, and is a flowchart illustrating a second control method;

FIG. 6 is a view for explaining movement of a reception part when control by the second control method is performed, and is a side view schematically showing a position of the reception part in a state where a pressing force of any one of outer blade pieces exceeds a predetermined value;

FIG. 7 is a view for explaining the movement of the reception part when the control by the second control method is performed, and is a side view schematically showing a state in which the reception part of the outer blade piece having a value less than a predetermined value is moved upward;

FIG. 8 is a flowchart illustrating a control method using a load adjustment mechanism and a second load adjustment mechanism according to the exemplary embodiment, and is a flowchart illustrating a third control method;

FIG. 9 is a view for explaining movement of the reception part and a second reception part when control by the third control method is performed, and is a side view schematically showing positions of the reception part and the second reception part in a state where a pressing force of any one of the outer blade pieces exceeds a predetermined value;

FIG. 10 is a view for explaining movement of the reception part and the second reception part when control by the third control method is performed, and is a side view schematically showing positions of the reception part and the second reception part in a state where pressing forces of all the outer blade pieces become less than or equal to a predetermined value;

FIG. 11 is a flowchart illustrating a control method using a load adjustment mechanism and a second load adjustment mechanism according to the exemplary embodiment, and is a flowchart illustrating a fourth control method;

FIG. 12 is a flowchart showing an example of a method of controlling the outer blade when a fourth control method is performed;

FIG. 13 is a flowchart illustrating an example of a method of controlling a skin guard part when the fourth control method is performed;

FIG. 14 is a view for explaining movement of the reception part and the second reception part when control by the fourth control method is performed, and is a side view schematically showing the positions of the reception part and the second reception part in a state where the pressing force of any one piece exceeds a predetermined value;

FIG. 15 is a view for explaining the movement of the reception part and the second reception part when the control by the fourth control method is performed, and is a side view schematically showing the positions of the reception part and the second reception part in a state where the pressing forces of all the pieces have a predetermined value;

FIG. 16 is a flowchart illustrating a control method using a load adjustment mechanism and a second load adjustment mechanism according to the exemplary embodiment, and is a flowchart illustrating a fifth control method;

FIG. 17 is a view for explaining movement of the reception part and the second reception part when control by the fifth control method is performed, and is a side view schematically showing the positions of the reception part and the second reception part in a state where the pressing force of any one piece exceeds a predetermined value;

FIG. 18 is a view for explaining the movement of the reception part and the second reception part when the control by the fifth control method is performed, and is a side view schematically illustrating a state in which the reception part of the piece having a value more than or equal to a predetermined value is moved downward;

FIG. 19 is a flowchart illustrating a control method using a load adjustment mechanism and a second load adjustment mechanism according to the exemplary embodiment, and is a flowchart illustrating a sixth control method;

FIG. 20 is a view for explaining movement of the reception part and the second reception part when the control by the sixth control method is performed, and is a side view schematically showing the positions of the reception part and the second reception part in a state where the pressing force of any one piece exceeds a predetermined value;

FIG. 21 is a view for explaining the movement of the reception part and the second reception part when the control by the sixth control method is performed, and is a side view schematically illustrating a state in which the reception part and the second reception part of the piece having a value less than a predetermined value are moved upward;

FIG. 22 is a block diagram illustrating a function of an electric shaver according to a first modification;

FIG. 23 is a flowchart illustrating a control method using a load adjustment mechanism included in the electric shaver according to the first modification, and is a flowchart illustrating a seventh control method;

FIG. 24 is a block diagram illustrating a function of an electric shaver according to a second modification;

FIG. 25 is a flowchart illustrating a control method using a load adjustment mechanism included in the electric shaver according to the second modification, and is a flowchart illustrating an eighth control method;

FIG. 26 is a view showing a head part and an outer blade block included in an electric shaver according to a third modification, and is a front view schematically showing a state in which the outer blade block is attached to the head part;

FIG. 27 is a view showing the head part and the outer blade block included in the electric shaver according to the third modification, and is a front view schematically showing a state in which the outer blade block is removed from the head part; and

FIG. 28 is a side view schematically illustrating an outer blade block included in an electric shaver according to a fourth modification.

### DETAILED DESCRIPTIONS

Hereinafter, exemplary embodiments will be described in detail with reference to the drawings. However, unnecessarily detailed description may be omitted. For example, a detailed description of a well-known matter or a repeated description of substantially the same configuration may be omitted.

Note that, the accompanying drawings and the following description are merely presented to help those skilled in the art fully understand the present disclosure, and are not intended to limit the subject matters described in the scope of claims.

In the following exemplary embodiment and its modifications, a direction in which the plurality of blade blocks are arranged side by side is described as front-back direction X (that is, the shaving direction), and a direction in which each blade block extends is described as left-right direction Y.

The vertical direction in a state where the head part (that is, one element of the electric shaver) is disposed such that the skin contact surface faces upward is referred to as vertical direction Z (that is, an example of the term “one direction”). Vertical direction Z is also referred to as a float direction. In the present exemplary embodiment, the skin contact surface of the blade unit includes the surfaces of the outer blade pieces of the plurality of blade blocks, and is a surface that can be approximated by a curved surface that protrudes outward as a whole. The surface of the outer blade piece of the blade block is also referred to as an outer surface. Therefore, in the following exemplary embodiments and modifications thereof, a state in which the point protruding to the outermost side of the curved surface which approximates to the skin contact surface of the blade unit is located at the uppermost portion and the contact plane at the point protruding to the outermost side of the curved surface which approximates to the skin contact surface of the blade unit is a horizontal plane is a state in which the head part (that is, one element of the shaver body) is disposed such that the skin contact surface faces upward.

In the following exemplary embodiment and its modifications, a side of the electric shaver on which the power switch is provided will be described as a front side in front-back direction X.

### Exemplary Embodiment

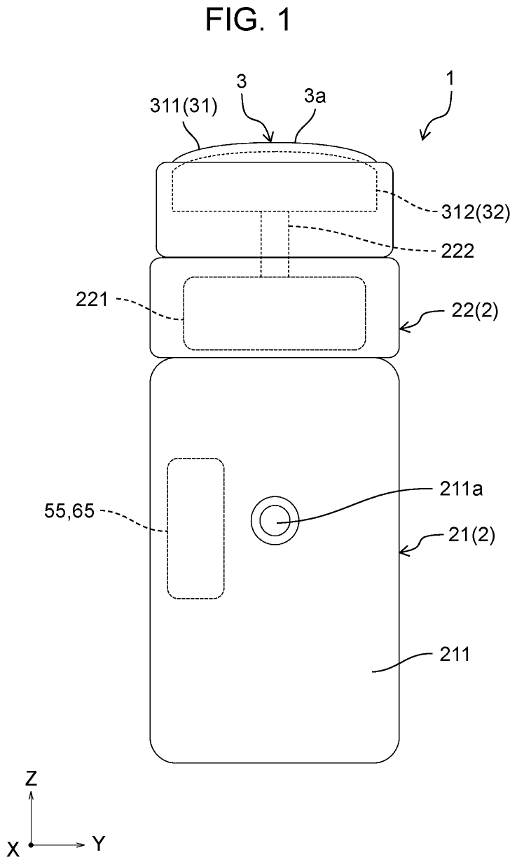

FIG. 1 is a front view schematically illustrating an example of electric shaver 1 according to an exemplary embodiment. As shown in FIG. 1, electric shaver 1 according to the present exemplary embodiment includes: shaver body 2; and blade unit 3 that is held on shaver body 2 in a state where skin contact surface 3a (that is, the surface of the outer blade of each blade block, which will be described later) is exposed.

Shaver body 2 includes grip part 21 that can be held by hand, and head part 22 supported by grip part 21. In the present exemplary embodiment, head part 22 is supported by grip part 21 in a state where an extending direction of grip part 21 substantially accords with vertical direction Z. At this time, head part 22 can be supported by grip part 21 in a state of being inclined upward and forward.

Furthermore, head part 22 can be swung in left-right direction Y with respect to grip part 21 using a shaft portion (not illustrated) extending in front-back direction X as an axis. Head part 22 can also be swung in front-back direction X with respect to grip part 21 using a shaft portion (not illustrated) extending in left-right direction Y as an axis. Furthermore, head part 22 can float in vertical direction Z with respect to grip part 21.

It is also possible to adopt a configuration in which these swings and floats are appropriately combined. For example, head part 22 may be configured to be swingable in front-back direction X and left-right direction Y with respect to grip part 21 and float in vertical direction Z with respect to grip part 21.

Head part 22 may be configured not to swing or float with respect to grip part 21.

Grip part 21 includes main body housing 211, and a cavity is formed inside main body housing 211. Various electric components such as controller 55 (see FIG. 3), second controller 65 (see FIG. 3), and a rechargeable battery (not illustrated) are accommodated in the cavity formed inside main body housing 211.

Main body housing 211 is provided with press-type power switch 211a that operates electric shaver 1. That is, power switch 211a is used to turn on and off electric shaver 1. In the present exemplary embodiment, a press-type switch is exemplified as power switch 211a, but other switches such as a slide switch may be used as long as the switches can turn on and off the power.

In the present exemplary embodiment, power switch 211a is formed on a front surface of main body housing 211, that is, on a front surface (that is, the front surface) of electric shaver 1. Note that the front surface of electric shaver 1 refers to a surface facing a user in a state where the user grips grip part 21 of electric shaver 1 during normal use.

Further, a trimmer unit may be provided at a rear portion (that is, the rear part of electric shaver 1) of main body housing 211 or the like.

On the other hand, driving mechanism 221 is accommodated in head part 22, and driving mechanism 221 includes a plurality of driving culms 222. In the present exemplary embodiment, driving mechanism 221 is accommodated in head part 22 in a state where driving culm 222 protrudes upward from head part 22. As such a driving mechanism, for example, a conventionally known driving mechanism such as a vibration type linear actuator, a driving mechanism including a rotary motor and a conversion mechanism that converts rotational motion into reciprocating linear motion, and the like can be used.

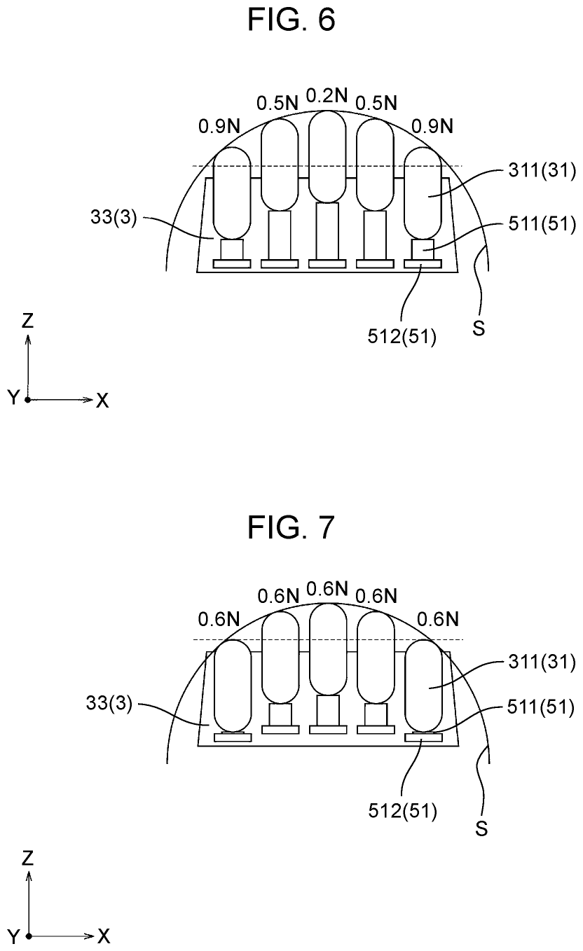

As illustrated in FIG. 6, which will be described in detail later, blade unit 3 includes a plurality of blade blocks 31, and the plurality of blade blocks 31 are arranged so as to be aligned in front-back direction X in a state where the longitudinal direction accords with left-right direction Y. As described above, in the present exemplary embodiment, each of blade blocks 31 has a predetermined length and width, and these blade blocks 31 are disposed in a state where their length direction substantially accords with left-right direction Y of electric shaver 1 and where their width direction substantially accords with front-back direction X (that is, the shaving direction) of electric shaver 1. Although FIG. 6 exemplifies a case where blade unit 3 includes five blade blocks 31, the number of blade blocks 31 is not limited to five, and may be any number.

Each of the plurality of blade blocks 31 includes outer blade piece 311 (that is, the outer blade) and inner blade 312. Each of outer blade pieces 311 (that is, the outer blade) is curved in an inverted U shape so as to protrude upward in a side view (that is, in a state viewed along left-right direction Y). Therefore, in the present exemplary embodiment, skin contact surface 3a of blade unit 3 includes the surfaces (that is, the outer surface) of the outer blades of the plurality of blade blocks 31, and is a surface that can be approximated by a curved surface that protrudes outward as a whole.

Outer blade pieces 311 (that is, the outer blade) may be configured not to be curved so as to protrude upward in front view (that is, viewed along front-back direction X). For example, when outer blade pieces 311 (that is, the outer blade) are viewed from the front (that is, viewed along front-back direction X), the tops of outer blade pieces 311 (that is, the outer blade) can be a straight line extending in left-right direction Y (that is, outer blade length direction). Outer blade pieces 311 (that is, the outer blade) may be formed to be slightly curved along left-right direction Y (that is, outer blade length direction) so as to protrude upward in front view (that is, viewed along front-back direction X).

Further, the plurality of blade blocks 31 can be formed of a net blade block and a slit blade block. Here, the net blade block is formed with a large number of circular blade holes (not shown), and has a function of cutting off mainly a fallen whisker (that is, one example of body hair) and a short standing whisker (that is, one example of body hair). The slit blade block is formed with a large number of slit-shaped blade holes (not shown), and has a function of cutting off mainly a thin long whisker (that is, one example of body hair).

Each of inner blades 312 has an inverted U shape that conforms to the curved shape of outer blade piece 311, and is disposed inside outer blade piece 311 (that is, the lower side of outer blade piece 311, more specifically, the side opposite to the side of outer blade piece 311 in contact with skin S). This inner blade 312 is detachably attached to one of the plurality of driving culms 222. Further, in the present exemplary embodiment, when electric shaver 1 is powered on and driving culms 222 are driven with inner blades 312 attached to driving culms 222 and disposed inside outer blade pieces 311, inner blades 312 are displaced relative to outer blade pieces 311 (that is, moved relatively, more specifically, reciprocated in left-right direction Y) while being in sliding contact with the inner surfaces of outer blade pieces 311.

As described above, electric shaver 1 according to the present exemplary embodiment has the form of a reciprocating electric shaver in which inner blades 312 are reciprocated with respect to outer blade pieces 311.

In the present exemplary embodiment, in the plurality of blade blocks 31, members other than inner blades 312 attached to driving culms 222 are attached to holding frame 33 (that is, an example of the holding member) having a substantially frame shape. At this time, each member may be detachably attached to holding frame 33 (that is, an example of the holding member), or may be attached to holding frame 33 (that is, an example of the holding member) in a state where each member cannot be attached or detached.

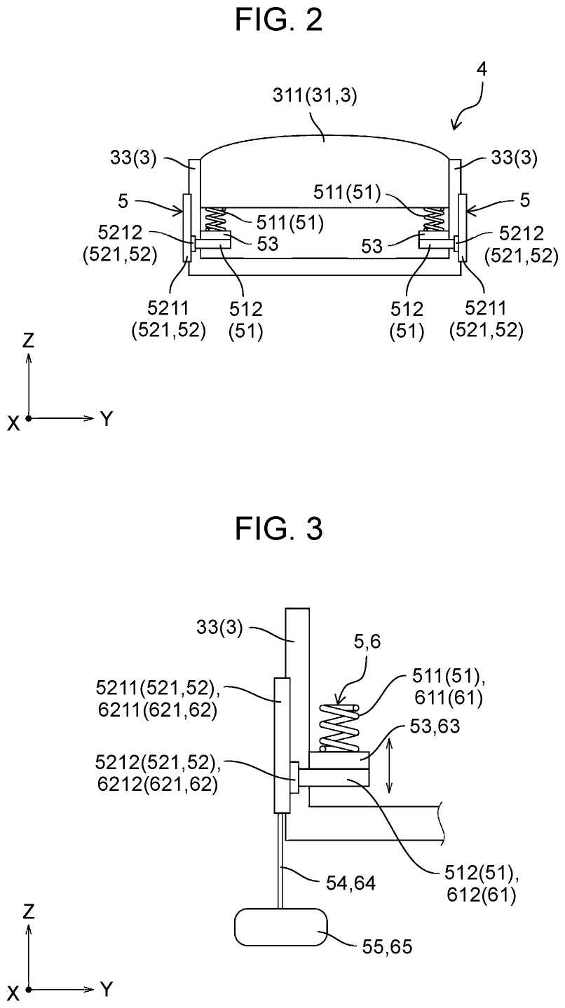

In the present exemplary embodiment, the plurality of blade blocks 31 except inner blades 312 attached to driving culms 222 are attached to holding frame 33 (that is, an example of the holding member), so that outer blade cassette 4 (that is, the outer blade block) is formed as illustrated in FIG. 2, which will be described in detail later. This outer blade cassette 4 (that is, the outer blade block) 4 is detachably attached to head part 22. In the present exemplary embodiment, when outer blade cassette 4 (that is, the outer blade block) is attached to head part 22 in a state where the plurality of inner blades 312 are attached to driving culms 222, the plurality of inner blades 312 are disposed inside corresponding outer blade pieces 311.

Accordingly, when electric shaver 1 is powered on, inner blades 312 are displaced relative to corresponding outer blade pieces 311 (that is, the outer blade). In other words, inner blades 312 are moved relatively to corresponding outer blade pieces 311 (that is, the outer blade), more specifically, reciprocated in left-right direction Y.

Electric shaver 1 is powered on, and skin contact surface 3a of blade unit 3 is brought into contact with skin S of the user and moved while being slid in front-back direction X in a state where inner blades 312 are displaced relative to corresponding outer blade pieces 311 (that is, the outer blade), so that the whiskers (that is, one type of body hair) inserted into the blade holes of outer blade pieces 311 (that is, the outer blade) are cut by outer blade pieces 311 (that is, the outer blade) and inner blades 312. Skin S of the user is also referred to as a skin surface.

Note that head part 22 may include a head part main body in which driving mechanism 221 is accommodated inside in a state in which driving culms 222 protrude upward, and attached to grip part 21, and a substantially tubular head cover detachably attached to the head part main body. Outer blade cassette 4 (that is, the outer blade block) may be detachably attached to the head cover in a state where the surface of each outer blade piece is exposed from the opening of the head cover. That is, electric shaver 1 can be formed by attaching the head cover to which outer blade cassette 4 (that is, the outer blade block) is attached to the head part main body in a state where the plurality of inner blades 312 are attached to driving culms 222 protruding upward from the head part main body.

In the present exemplary embodiment, outer blade pieces 311 (that is, the outer blade) can be pressed against skin S with a more appropriate pressing force (more specifically, the pressing load).

Specifically, electric shaver 1 includes load adjustment mechanism 5 capable of adjusting a load (that is, the load applied to the outer blade) applied to outer blade pieces 311 (that is, the outer blade).

Load adjustment mechanism 5 includes float mechanism 51 that floats outer blade pieces 311 (that is, the outer blade) in vertical direction Z (that is, an example of the term “in one direction”). Float mechanism 51 includes outer blade pieces 311 (that is, spring 511 (that is, an example of the biasing member) that biases the outer blade upward (that is, an example of “toward one side”) in vertical direction Z (that is, an example of the term “in one direction”), and spring pedestal 512 (that is, an example of the reception part) that receives spring 511 (that is, an example of the biasing member).

In the present exemplary embodiment, each of five blade blocks 31 is attached to holding frame 33 (that is, an example of the holding member) in a state of being able to float separately and independently in vertical direction Z. Thus, when outer blade cassette 4 (that is, the outer blade block) is attached to head part 22, each blade block 31 floats separately and independently from head part 22 (that is, one element of shaver body 2). Outer blade pieces (more specifically, skin contact surface 3a of blade unit 3) can more reliably follow the shape of skin S, and can more reliably cut whisker (that is, one example of body hair).

Such a configuration can be obtained by, for example, as shown in FIG. 2, arranging spring pedestals 512 (that is, an example of the reception part) below respective blade blocks 31 in a state where respective blade blocks 31 are arranged such that the inverted U-shaped top portions of outer blade pieces 311 face upward, and interposing springs 511 (that is, an example of the biasing member) between respective blade blocks 31 and spring pedestals 512 (that is, an example of the reception part) therebelow.

At this time, it is preferable that each blade block 31 is attached to holding frame 33 (that is, an example of the holding member) so as to be floatable in vertical direction Z in a state where respective blade blocks are prevented from coming off from above while spring pedestals 512 (that is, an example of the reception part) is attached to holding frame 33 (that is, an example of the holding member). Even in the state where coming off from above is prevented, it is preferable that outer blade pieces 311 (that is, the outer blade) be biased upward (that is, an example of “toward one side”) in vertical direction Z (that is, an example of the term “in one direction”) by springs 511 (that is, an example of the biasing member). In this manner, each of five blade blocks 31 is attached to holding frame 33 (that is, an example of the holding member) so as to float separately and independently in vertical direction Z while being biased upward also at a top dead center.

However, in a state where spring pedestals 512 (that is, an example of the reception part) are fixed to holding frame 33 (that is, an example of the holding member) when spring pedestals 512 (that is, an example of the reception part) are attached to holding frame 33 (that is, an example of the holding member), outer blade pieces 311 (that is, the outer blade) cannot be pressed against skin S with an appropriate pressing force in a case where outer blade pieces 311 are pressed against skin S too strongly or a pressing force of outer blade pieces 311 against skin S becomes too weak when electric shaver 1 is used.

Therefore, in the present exemplary embodiment, load adjustment mechanism 5 includes movable mechanism 52 capable of moving spring pedestals 512 (that is, an example of the reception part) in vertical direction Z (that is, an example of the term “in one direction”). By providing such movable mechanism 52, it is possible to adjust a pressing force (that is, the pressing load) of outer blade pieces 311 (that is, the outer blade) to skin S when outer blade pieces 311 are pressed against skin S too strongly or a pressing force of outer blade pieces 311 to skin S becomes too weak.

FIG. 2 is a front view schematically illustrating an example of outer blade cassette 4 (that is, the outer blade block) included in electric shaver 1 according to the exemplary embodiment. FIG. 3 is a front view schematically illustrating an example of load adjustment mechanism 5 and second load adjustment mechanism 6 according to the exemplary embodiment. In the present exemplary embodiment, as illustrated in FIGS. 2 and 3, movable mechanism 52 includes slide motor 521 as a drive source. Slide motor 521 includes fixed part 5211 and movable part 5212 that moves on fixed part 5211 in one direction. Then, in a state where one direction (that is, the moving direction of movable part 5212 with respect to fixed part 5211) is vertical direction Z, fixed part 5211 is fixed to holding frame 33 (that is, an example of the holding member), and spring pedestal 512 (that is, an example of the reception part) is fixed to movable part 5212. In this way, while spring pedestal 512 (that is, an example of the reception part) can be moved relative to holding frame 33 (that is, an example of the holding member) in vertical direction Z (that is, an example of the term “in one direction”), each of five blade blocks 31 is attached to holding frame 33 (that is, an example of the holding member) so as to float separately and independently in vertical direction Z.

Moreover, load adjustment mechanism 5 includes sensor 53 that detects a load applied to outer blade pieces 311 (that is, the outer blade). In the present exemplary embodiment, sensor 53 is disposed between spring pedestal 512 (that is, an example of the reception part) and spring 511 (that is, an example of the biasing member), and elastic restoring force of spring 511 (that is, an example of the biasing member) is detected by sensor 53, so that a load applied to outer blade pieces 311 (that is, the outer blade) is detected.

Load adjustment mechanism 5 includes controller 55 that controls a movement amount of spring pedestal 512 (that is, an example of the reception part) in vertical direction Z (that is, an example of the term “in one direction”) based on the load applied to outer blade pieces 311 (that is, the outer blade) detected by sensor 53. Controller 55 can be provided, for example, on a circuit board accommodated inside main body housing 211. Note that movable mechanism 52 and sensor 53 are electrically connected to controller 55 by wiring 54.

As described above, in electric shaver 1 according to the present exemplary embodiment, the position of spring pedestal 512 that receives spring 511 can be controlled while outer blade pieces 311 are biased upward in vertical direction Z by spring 511.

Consequently, it is possible to appropriately change a pressing force (that is, the pressing load) of outer blade pieces 311 to skin S with respect to a pressing amount (that is, a downward movement amount of outer blade pieces 311 from the top dead center) of outer blade pieces 311 to skin S. For example, when electric shaver 1 is used, even if outer blade pieces 311 are pressed against skin S too strongly, or even if the pressing force of outer blade pieces 311 against skin S becomes too weak, outer blade pieces 311 can be pressed against skin S with a more appropriate pressing force (that is, the pressing load).

As described above, use of electric shaver 1 described in the present exemplary embodiment can prevent outer blade pieces 311 from being pressed against skin S too strongly or can prevent pressing force of outer blade pieces 311 against skin S from becoming too weak. As a result, outer blade pieces 311 can be pressed against skin S with a more appropriate pressing force (that is, the pressing load), so that it is possible to reduce a burden on skin S while suppressing a decrease in cutting efficiency of a whisker (that is, one example of body hair) during shaving (that is, when electric shaver 1 is used).

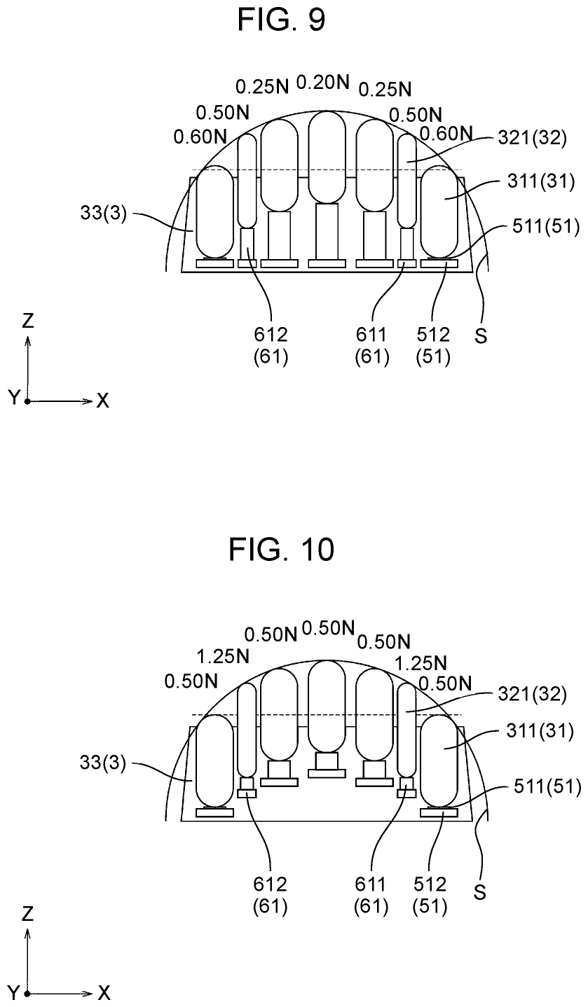

Blade unit 3 may include skin guard block 32. At this time, blade unit 3 may include a plurality of skin guard blocks 32. For example, as illustrated in FIG. 9, which will be described in detail later, the plurality of skin guard blocks 32 can be arranged between blade blocks 31 arranged side by side in front-back direction X in a state where the longitudinal direction accords with left-right direction Y. As described above, in electric shaver 1 shown in FIG. 9, each skin guard block 32 has a predetermined length and width, and skin guard blocks 32 are arranged such that the length direction substantially accords with left-right direction Y of electric shaver 1, and such that the width direction substantially accords with front-back direction X (that is, the shaving direction) of electric shaver 1. Note that FIG. 9 illustrates an example in which blade unit 3 includes five blade blocks 31 and two skin guard blocks 32. However, the number of blade blocks 31 is not limited to five, and may be various. Similarly, the number of skin guard blocks 32 is not limited to two, and may be various.

Each of the plurality of skin guard blocks 32 includes a skin guard piece 321 (that is, an example of the skin guard part), and each skin guard piece 321 (that is, an example of the skin guard part) is formed to be curved in an inverted U shape so as to protrude upward in a side view (that is, viewed along left-right direction Y). During use of electric shaver 1, skin S (that is, the skin surface) of the user is brought into contact with a surface (more specifically, the curved surface having no hole) of skin guard piece 321 (that is, an example of the skin guard part), so that the stimulation applied to skin S can be reduced.

Skin guard piece 321 (that is, an example of the skin guard part) can also be configured not to be curved so as to protrude upward in a front view (that is, viewed along front-back direction X), or can be formed to be slightly curved along left-right direction Y (that is, outer blade length direction) so as to protrude upward in a front view (that is, viewed along front-back direction X).

Members other than inner blades 312 attached to driving culms 222 of the plurality of blade blocks 31 and the plurality of skin guard blocks 32 are attached to substantially frame-shaped holding frame 33 (that is, an example of the holding member). At this time, each member of blade blocks 31 and the plurality of skin guard blocks 32 may be detachably attached to holding frame 33 (that is, an example of the holding member), or may be attached to holding frame 33 (that is, an example of the holding member) in a state where they cannot be attached.

As described above, when blade unit 3 includes the plurality of skin guard blocks 32, the plurality of blade blocks 31 excluding the inner blades 312 attached to driving culms 222 and the plurality of skin guard blocks 32 are attached to the holding frame 33 (that is, an example of the holding member), whereby outer blade cassette 4 (that is, the outer blade block) is formed.

When blade unit 3 includes skin guard block 32, electric shaver 1 includes second load adjustment mechanism 6 capable of adjusting a load (that is, the load applied to the skin guard part) applied to skin guard piece 321 (that is, an example of the skin guard part).

Specifically, as shown in FIG. 3, second load adjustment mechanism 6 includes second float mechanism 61 that floats skin guard piece 321 (that is, an example of the skin guard part) in vertical direction Z (that is, an example of the term “in one direction”). This second float mechanism 61 includes second spring 611 (that is, an example of the second biasing member) that biases skin guard piece 321 (that is, an example of the skin guard part) upward (that is, an example of “toward one side”) in vertical direction Z (that is, an example of the term “in one direction”), and a second spring pedestal 612 (that is, an example of the second reception part) that receives second spring 611 (that is, an example of the second biasing member).

In electric shaver 1 shown in FIG. 9, each of two skin guard blocks 32 is attached to holding frame 33 (that is, an example of the holding member) so as to be floatable in vertical direction Z separately and independently of each other. Thus, when outer blade cassette 4 (that is, the outer blade block) is attached to head part 22, each skin guard block 32 floats separately and independently from head part 22 (that is, one element of shaver body 2). Then, the pressing force from skin S can also be dispersed to skin guard piece 321 (that is, an example of the skin guard part), and the load per one outer blade piece 311 (that is, the outer blade) can be further reduced. Thus, shaving can be performed (that is, electric shaver 1 is used) while reducing the burden on skin S more reliably.

Such a configuration can also be obtained by arranging second spring pedestal 612 (that is, an example of the second reception part) below each skin guard block 32 in a state where each skin guard block 32 is disposed such that the inverted U-shaped top portion of skin guard piece 321 (that is, an example of the skin guard part) faces upward, and interposing second spring 611 (that is, an example of the second biasing member) between each skin guard block 32 and second spring pedestal 612 (that is, an example of the second reception part) therebelow.

At this time, it is preferable to attach each skin guard block 32 to holding frame 33 (that is, an example of the holding member) so as to float in vertical direction Z on holding frame 33 (that is, an example of the holding member) in a state where coming off from above is prevented while attaching second spring pedestal 612 (that is, an example of the second reception part) to holding frame 33. Even in the state where the coming off from above is prevented, skin guard piece 321 (that is, an example of the skin guard part) is preferably biased to the upper side (that is, an example of “toward one side”) in vertical direction Z (that is, an example of the term “in one direction”) by second spring 611 (that is, an example of the second biasing member). Thus, each of two skin guard blocks 32 is attached to holding frame 33 (that is, an example of the holding member) so as to float separately and independently in vertical direction Z while being biased upward also at the top dead center.

Second load adjustment mechanism 6 includes second movable mechanism 62 capable of moving second spring pedestal 612 (that is, an example of the second reception part) in vertical direction Z (that is, an example of the term “in one direction”). By providing such second movable mechanism 62, it is possible to adjust a pressing force (that is, the pressing load) of skin guard piece 321 (that is, an example of the skin guard part) to skin S.

This second movable mechanism 62 includes second slide motor 621 as a second drive source. This second slide motor 621 includes second fixed portion 6211 and second movable part 6212 that moves in one direction on second fixed portion 6211. Then, in a state where one direction (that is, the moving direction of second movable part 6212 with respect to second fixed portion 6211) is vertical direction Z, second fixed portion 6211 is fixed to holding frame 33 (that is, an example of the holding member), and second spring pedestal 612 (that is, an example of the second reception part) is fixed to second movable part 6212. Thus, while second spring pedestal 612 (that is, an example of the second reception part) can be moved relative to holding frame 33 (that is, an example of the holding member) in vertical direction Z (that is, an example of the term “in one direction”), each of two skin guard blocks 32 is attached to holding frame 33 (that is, an example of the holding member) so as to float separately and independently in vertical direction Z.

Furthermore, second load adjustment mechanism 6 includes second sensor 63 that detects a load applied to skin guard piece 321 (that is, an example of the skin guard part). In electric shaver 1 shown in FIG. 9, second sensor 63 is disposed between second spring pedestal 612 (that is, an example of the second reception part) and second spring 611 (that is, an example of the second biasing member), and elastic restoring force of second spring 611 (that is, an example of the second biasing member) is detected by second sensor 63, so that a load applied to skin guard piece 321 (that is, an example of the skin guard part) is detected.

Second load adjustment mechanism 6 includes second controller 65 that controls a movement amount of second spring pedestal 612 (that is, an example of the second reception part) in vertical direction Z (that is, an example of the term “in one direction”) based on the load applied to skin guard piece 321 (that is, an example of the skin guard part) detected by second sensor 63. This second controller 65 can be provided, for example, on a circuit board accommodated inside main body housing 211. Note that controller 55 can also serve as second controller 65, or second controller 65 can be provided separately from controller 55. In a case where second controller 65 is provided separately from controller 55, second controller 65 can be provided on the same circuit board, or can be provided on a circuit board different from the circuit board on which controller 55 is provided. Second movable mechanism 62 and second sensor 63 are electrically connected to second controller 65 by second wiring 64.

As described above, second load adjustment mechanism 6 has substantially the same configuration as load adjustment mechanism 5. In electric shaver 1 shown in FIG. 9, second spring 611 biases skin guard piece 321 (that is, an example of the skin guard part) upward in vertical direction Z, and a position of second spring pedestal 612 that receives second spring 611 can be controlled.

Thus, the pressing force (that is, the pressing load) of skin guard piece 321 (that is, an example of the skin guard part) to skin S with respect to the pressing amount (that is, the downward movement amount of skin guard piece 321 from the top dead center) of skin guard piece 321 (that is, an example of the skin guard part) to skin S can be appropriately changed.

In the present exemplary embodiment, as described above, electric shaver 1 is formed by attaching outer blade cassette 4 (that is, the outer blade block) to head part 22. Therefore, outer blade cassette 4 (that is, the outer blade block) can be used in electric shaver 1 shown in the present exemplary embodiment and electric shaver 1 shown in FIG. 9. Accordingly, outer blade cassette 4 (that is, the outer blade block) for use in electric shaver 1 according to the present exemplary embodiment includes outer blade pieces 311 (that is, the outer blade), and holding frame 33 (that is, an example of the holding member) that is detachably attached to shaver body 2 while holding outer blade pieces 311 (that is, the outer blade). When holding frame 33 (that is, an example of the holding member) is attached to shaver body 2 while holding outer blade pieces 311 (that is, the outer blade), a load applied to outer blade pieces 311 (that is, the outer blade) can be adjusted by load adjustment mechanism 5.

Thus, outer blade cassette 4 (that is, the outer blade block) capable of pressing outer blade pieces 311 (that is, the outer blade) against skin S with a more appropriate pressing force can be obtained. Even when outer blade cassette 4 (that is, the outer blade block) detachably attached to shaver body 2 is used, outer blade pieces 311 can be pressed against skin S with a more appropriate pressing force.

On the other hand, outer blade cassette 4 (that is, the outer blade block) used in electric shaver 1 shown in FIG. 9 includes outer blade pieces 311 (that is, the outer blade), skin guard pieces 321 (that is, an example of the skin guard part), and holding frame 33 (that is, an example of the holding member) that is detachably attached to shaver body 2 while holding outer blade pieces 311 (that is, the outer blade) and skin guard pieces 321 (that is, an example of the skin guard part). When holding frame 33 (that is, an example of the holding member) is attached to shaver body 2 while holding outer blade pieces 311 (that is, the outer blade) and skin guard pieces 321 (that is, an example of the skin guard part), a load applied to outer blade pieces 311 (that is, the outer blade) can be adjusted by load adjustment mechanism 5. The load applied to skin guard pieces 321 (that is, an example of the skin guard part) can be adjusted by second load adjustment mechanism 6.

Thus, outer blade cassette 4 (that is, the outer blade block) capable of pressing outer blade pieces 311 (that is, an example of the skin guard part) against skin S with a more appropriate pressing force while allowing the pressing force from skin S to be dispersed also to skin guard pieces 321 (that is, the outer blade) is configured to be able to be obtained. Even when outer blade cassette 4 (that is, the outer blade block) detachably attached to shaver body 2 is used, outer blade pieces 311 can be pressed against skin S with a more appropriate pressing force.

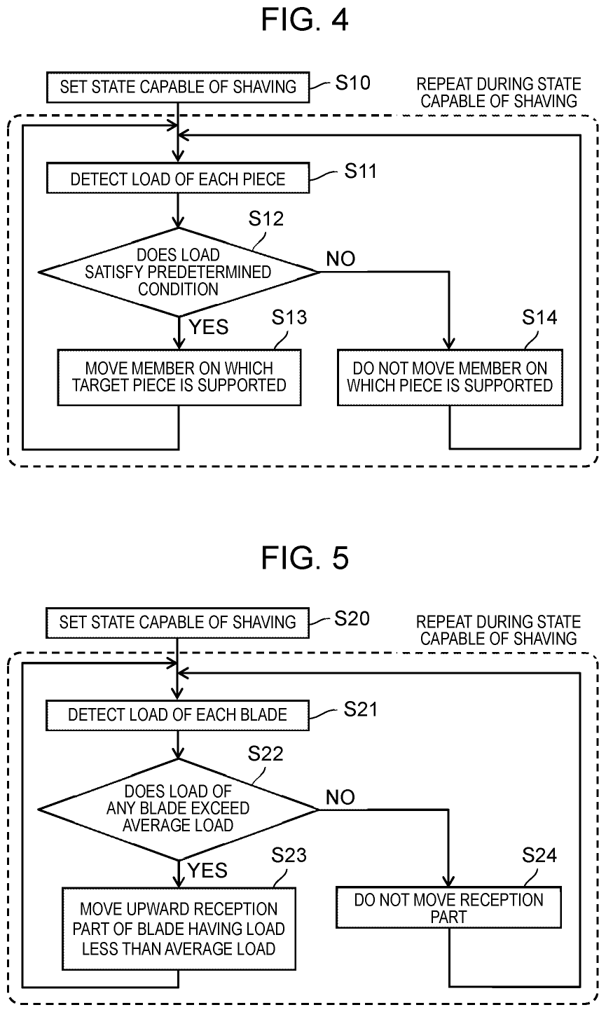

By the way, when shaving is performed using electric shaver 1 configured as described above, control as shown in FIG. 4 is generally performed. Hereinafter, specific contents of the control illustrated in FIG. 4 will be described. FIG. 4 is a flowchart illustrating a first control method as a general example of a method of controlling electric shaver 1 according to the exemplary embodiment.

First, electric shaver 1 is brought into a state capable of shaving (step S10).

Specifically, electric shaver 1 is powered on so that shaving can be performed.

Next, the load of each piece is detected by the sensor (step S11).

Specifically, when blade unit 3 includes blade block 31 but does not include skin guard block 32, sensor 53 detects a load applied to outer blade pieces 311 (that is, the outer blade).

When blade unit 3 includes blade block 31 and skin guard block 32, sensor 53 detects a load applied to outer blade pieces 311 (that is, the outer blade), and second sensor 63 detects a load applied to skin guard piece 321 (that is, an example of the skin guard part).

Next, it is determined whether or not the load of each piece detected by the sensor satisfies a predetermined condition (step S12).

Specifically, when blade unit 3 includes blade block 31 but does not include skin guard block 32, controller 55 determines whether or not the load detected by sensor 53 satisfies a predetermined condition.

When blade unit 3 includes blade block 31 and skin guard block 32, controller 55 determines whether or not the load detected by sensor 53 satisfies a predetermined condition, and second controller 65 determines whether or not the load detected by second sensor 63 satisfies a predetermined condition.

When it is determined as “YES” in step S12, the process proceeds to step S13. That is, the member on which the target piece is supported is moved.

Specifically, when blade unit 3 includes blade block 31 but does not include skin guard block 32, controller 55 moves spring pedestal 512 (that is, an example of the reception part) that receives target outer blade pieces 311 (that is, the outer blade). Therefore, in this case, spring pedestal 512 (that is, an example of the reception part) that receives target outer blade pieces 311 (that is, the outer blade) is a member on which the target piece is supported.

When blade unit 3 includes blade block 31 and skin guard block 32, controller 55 moves spring pedestal 512 (that is, an example of the reception part) that receives target outer blade pieces 311 (that is, the outer blade), and second controller 65 moves second spring pedestal 612 (that is, an example of the second reception part) that receives target skin guard pieces 321 (that is, an example of the skin guard part). Therefore, in this case, spring pedestal 512 (that is, an example of the reception part) that receives target outer blade pieces 311 (that is, the outer blade) and second spring pedestal 612 (that is, an example of the second reception part) that receives target skin guard pieces 321 (that is, an example of the skin guard part) are member on which the target piece is supported. Since at least one target piece is sufficient, all of outer blade pieces 311 (that is, the outer blade) may be excluded from the target. In this case, second controller 65 only moves target second spring pedestal 612 (that is, an example of the second reception part, here, a member on which the piece is supported). Similarly, when all skin guard pieces 321 (that is, an example of the skin guard part) are excluded from the target, controller 55 only moves target spring pedestal 512 (that is, an example of the reception part, here, a member on which the piece is supported,).

Then, when the movement of all the members on which the piece are supported is completed, the process returns to step S11. That is, in a case where the target piece is only outer blade pieces 311 (that is, the outer blade), when the movement of spring pedestal 512 (that is, an example of the reception part) by controller 55 is completed, the process returns to step S11. In the case where the target piece is only skin guard piece 321 (that is, an example of the skin guard part), when the movement of second spring pedestal 612 (that is, an example of the second reception part) by second controller 65 is completed, the process returns to step S11. In a case where the target pieces are outer blade pieces 311 (that is, the outer blade) and skin guard piece 321 (that is, an example of the skin guard part), when the movement of spring pedestal 512 (that is, an example of the reception part) by controller 55 is completed and the movement of second spring pedestal 612 (that is, an example of the second reception part) by second controller 65 is completed, the process returns to step S11.

On the other hand, when “NO” is determined in step S12, the process proceeds to step S14. That is, all the members on which the pieces are supported are not allowed to move.

Specifically, when blade unit 3 includes blade block 31 but does not include skin guard block 32, all spring pedestals 512 (that is, an example of the reception part, here, a member on which the piece is supported) are prevented from moving. That is, controller 55 is prevented from moving spring pedestal 512 (that is, an example of the reception part).

Further, when blade unit 3 includes blade block 31 and skin guard block 32, all spring pedestals 512 (that is, an example of the reception part, here, a member to be supported) and all second spring pedestals 612 (that is, second reception part, here, the member on which the piece is supported) are prevented from moving. That is, the movement of spring pedestal 512 (that is, an example of the reception part) by controller 55 and the movement of second spring pedestal 612 (that is, an example of the second reception part) by second controller 65 are prevented.

Then, in a case where “NO” is determined in step S12 and the process proceeds to step S14, the process returns to step S11 without moving the member on which each piece is supported.

As described above, in the control shown in FIG. 4, when electric shaver 1 is in a state capable of shaving, the control in steps S11, S12, and S13 or the control in steps S11, S12, and S14 are repeatedly performed.

Here, by appropriately setting the predetermined condition determined in step S12, it is possible to perform control such that outer blade pieces 311 (that is, the outer blade) can be pressed against skin S with a more appropriate pressing force (that is, the pressing load) by various methods.

For example, in a case where blade unit 3 includes five blade blocks 31 but does not include skin guard block 32, the load applied to outer blade pieces 311 (that is, the outer blade) can be controlled by a method as illustrated in FIG. 5. FIG. 5 is a flowchart illustrating a control method using load adjustment mechanism 5 according to the exemplary embodiment, and is a flowchart illustrating a second control method. Hereinafter, specific contents of the control illustrated in FIG. 5 will be described with reference to FIGS. 6 and 7. FIG. 6 is a view for explaining movement of the reception part when control by the second control method is performed, and is a side view schematically showing a position of the reception part in a state where a pressing force of any one of outer blade pieces 311 (that is, the outer blade) exceeds a predetermined value. FIG. 7 is a view for explaining the movement of the reception part when the control by the second control method is performed, and is a side view schematically showing a state in which the reception part of outer blade pieces 311 (that is, the outer blade) having a value less than a predetermined value is moved upward.

First, electric shaver 1 is brought into a state capable of shaving (step S20).

Specifically, electric shaver 1 is powered on so that shaving can be performed.

Next, sensor 53 detects a load applied to outer blade pieces 311 (that is, the outer blade) (step S21).

Specifically, five sensors 53 detect loads applied to corresponding outer blade pieces 311 (that is, the outer blade), respectively. Then, an average load (that is, total load/number of blades) is calculated based on the load detected by each sensor 53. That is, a total of loads (that is, the total load) applied to outer blade pieces 311 (that is, the outer blade) detected by sensor 53 is calculated, and an average load (that is, total load/number of blades) is calculated by dividing the calculated total load by the number of blades (five blades in electric shaver 1 shown in FIG. 6).

Next, it is determined whether or not the load (that is, the load applied to any one of the outer blades) applied to any one of outer blade pieces 311 exceeds the calculated average load (that is, total load/number of blades) (step S22).

Specifically, it is determined whether or not a load exceeding an average load (that is, total of loads applied to all outer blade pieces 311/number of blades) is present among the loads applied to outer blade pieces 311 (that is, the outer blade) detected by sensor 53. For example, when electric shaver 1 having five outer blade pieces 311 (that is, the outer blade) is used, it is determined whether or not a load exceeding an average load (here, total of loads of five outer blade pieces 311/five) is present among the loads (here, five loads) applied to outer blade pieces 311 (that is, the outer blade) detected by sensor 53. This determination can be performed, for example, by providing a load determination unit in controller 55 or the like.

When it is determined as “YES” in step S22, the process proceeds to step S23. That is, spring pedestal 512 (that is, an example of the reception part, here, a member on which the piece is supported) that supports outer blade pieces 311 (that is, the outer blade) having a load less than the average load (that is, total load/number of blades) is moved upward.

Specifically, controller 55 moves upward spring pedestal 512 (that is, an example of the reception part, here, a member on which the piece is supported) that receives outer blade pieces 311 (that is, the outer blade) having a load less than (Total of loads applied to five outer blade pieces 311 (that is, the outer blade)/five).

For example, when the loads applied to outer blade pieces 311 (that is, the outer blade) respectively detected by five sensors 53 have values shown in FIG. 6, the total (that is, the total load) of the loads of five outer blade pieces 311 (that is, the outer blade) is 3.0N. The load applied to outer blade pieces 311 (that is, the outer blade) at both ends is 0.9N, that is, a value exceeding the average load (here, total of loads applied to five outer blade pieces 311 (that is, the outer blade)/five). On the other hand, the load applied to three outer blade pieces 311 at the center (that is, the outer blade) is less than 0.6N, that is, less than the average load (here, total of loads applied to five outer blade pieces 311 (that is, the outer blade)/five). Therefore, when the value shown in FIG. 6 is detected, controller 55 moves spring pedestal 512 (that is, an example of the reception part, here, a member on which the piece is supported) that supports three outer blade pieces 311 at the center (that is, the outer blade) upward in step S23. At this time, controller 55 controls the upward movement amount of three spring pedestals 512 at the center (that is, an example of the reception part, here, a member on which the piece is supported) so as to be in the state illustrated in FIG. 7. Specifically, controller 55 controls the upward movement amount of three spring pedestals 512 at the center (that is, an example of the reception part, here, a member on which the piece is supported) such that the load of each of five outer blade pieces 311 (that is, the outer blade) becomes 0.6N, that is, equivalent to the average load (here, total of loads applied to five outer blade pieces 311 (that is, the outer blade)/five).

When the movement of spring pedestal 512 (that is, an example of the reception part, here, a member on which the piece is supported) by controller 55 is completed, the process returns to step S21.

On the other hand, when “NO” is determined in step S22, the process proceeds to step S24. That is, controller 55 does not allow spring pedestal 512 (that is, an example of the reception part, here, a member on which the piece is supported) to move.

If “NO” is determined in step S22 and the process proceeds to step S24, the process returns to step S21 without moving spring pedestal 512 (that is, an example of the reception part, here, a member on which the piece is supported).

When electric shaver 1 is in a state capable of shaving, the control in steps S21, S22, and S23 or the control in steps S21, S22, and S24 are repeatedly performed.

By performing such control, controller 55 controls the movement amount of spring pedestal 512 (that is, an example of the reception part) in vertical direction Z (that is, an example of the term “in one direction”) so that the loads applied to the plurality of outer blade pieces 311 (that is, the outer blade) become substantially the same as one another. Therefore, concentration of the load applied to any one of the outer blade pieces 311 can be suppressed more reliably. That is, during shaving (that is, when electric shaver 1 is in use), the presence of outer blade pieces 311 each having a too strong pressing force against skin S and outer blade pieces 311 each having a too weak pressing force against skin S can be suppressed more reliably. Therefore, the burden on skin S when shaving is performed (that is, electric shaver 1 is used) can be reduced more reliably.

In addition, since all of the pressing forces of the plurality of outer blade pieces 311 against skin S can be substantially equal to each other, shaving performance (that is, an example of the cutting performance) can be sufficiently exhibited in all outer blade pieces 311 during shaving (that is, when electric shaver 1 is in use). As a result, the whisker (that is, one example of body hair) can be cut more efficiently and more reliably.

When blade unit 3 includes blade block 31 and skin guard block 32, the control shown in FIG. 5 can also be performed. In this case, in step S21, the load of each piece is detected by the sensor. That is, sensor 53 detects a load applied to outer blade pieces 311 (that is, the outer blade), and second sensor 63 detects a load applied to skin guard pieces 321 (that is, an example of the skin guard part). Then, the average load (that is, total load/number of pieces) is calculated based on the load applied to outer blade pieces 311 (that is, the outer blade) detected by each sensor 53 and the load applied to skin guard pieces 321 (that is, an example of the skin guard part) detected by each second sensor 63. That is, the average load (that is, total load/number of pieces) is calculated by calculating the sum of loads (that is, the total load) applied to outer blade pieces 311 (that is, the outer blade) detected by sensor 53 and loads applied to skin guard pieces 321 (that is, an example of the skin guard part) detected by second sensor 63, and dividing the calculated total load by the number of pieces.

In step S22, it is determined whether or not the load applied to any one of the pieces exceeds the calculated average load (that is, total load/number of pieces).

Specifically, it is determined whether or not there is a load exceeding the average load (that is, total of loads applied to the pieces/the number of pieces) among the load applied to the outer blade pieces 311 (that is, the outer blade) detected by sensor 53 and the load applied to skin guard pieces 321 (that is, an example of the skin guard part) detected by second sensor 63.

In step S23, the member on which the piece having a load less than the average load (that is, total of loads applied to the pieces/the number of pieces) is supported is moved upward.

Specifically, when outer blade pieces 311 (that is, the outer blade) having a load less than the average load (that is, total of loads applied to the pieces/the number of pieces) are present, controller 55 moves upward spring pedestal 512 (that is, an example of the reception part, here, a member on which the pieces are supported) on which outer blade pieces 311 (that is, the outer blade) having a load less than the average load (that is, total of loads applied to the pieces/the number of pieces) is supported. When skin guard pieces 321 (that is, an example of the skin guard part) having a load less than the average load (that is, total of loads applied to the pieces/the number of pieces) are present, second controller 65 moves upward second spring pedestal 612 (that is, second reception part, here, the member on which the pieces are supported) on which the skin guard pieces 321 (that is, an example of the skin guard part) having a load less than the average load (that is, total of loads applied to the pieces/the number of pieces) is supported.

In addition, in step S24, all the members on which pieces are supported are not allowed to move. That is, all spring pedestals 512 (that is, an example of the reception part, here, a member on which the piece is supported) and all second spring pedestals 612 (that is, the second reception part, here, the member on which the piece is supported) will not be allowed to move.

When blade unit 3 includes blade block 31 and skin guard block 32, only control on outer blade pieces 311 (that is, the outer blade) side as shown in FIG. 5 can be performed, or only control on skin guard pieces 321 (that is, an example of the skin guard part) side can be performed.

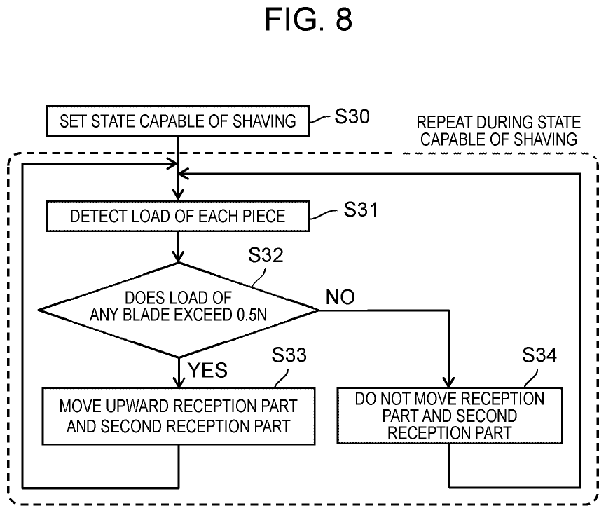

Furthermore, in a case where blade unit 3 includes five blade blocks 31 and two skin guard blocks 32, the load applied to outer blade pieces 311 (that is, the outer blade) can be controlled by a method as illustrated in FIG. 8. Hereinafter, specific contents of the control illustrated in FIG. 8 will be described with reference to FIGS. 9 and 10. FIG. 8 is a flowchart illustrating a control method using load adjustment mechanism 5 and second load adjustment mechanism 6 according to the exemplary embodiment, and is a flowchart illustrating a third control method. FIG. 9 is a view for explaining movement of the reception part and the second reception part when control by the third control method is performed, and is a side view schematically showing positions of the reception part and the second reception part in a state where a pressing force of any one of outer blade pieces 311 exceeds a predetermined value. FIG. 10 is a view for explaining movement of the reception part and the second reception part when control by the third control method is performed, and is a side view schematically showing positions of the reception part and the second reception part in a state where pressing forces of all outer blade pieces 311 become less than or equal to a predetermined value.

First, electric shaver 1 is brought into a state capable of shaving (step S30).

Specifically, electric shaver 1 is powered on so that shaving can be performed.

Next, the load of each piece is detected by the sensor (step S31).

Specifically, five sensors 53 detect loads applied to corresponding outer blade pieces 311 (that is, the outer blade), and two second sensors 63 detect loads applied to corresponding skin guard pieces 321 (that is, an example of the skin guard part).

Next, it is determined whether or not the pressing force of any one of outer blade pieces 311 exceeds 0.5N (that is, an example of a preset value) (step S32).

Specifically, it is determined whether or not any one of the loads applied to outer blade pieces 311 (that is, the outer blade) respectively detected by five sensors 53 exceeds 0.5N (that is, an example of a preset value).

When “YES” is determined in step S32, the process proceeds to step S33. That is, spring pedestal 512 (that is, an example of the reception part, here, a member on which the piece is supported,) that supports outer blade pieces 311 (that is, the outer blade) and second spring pedestal 612 (that is, the second reception part, here, the member on which the piece is supported) that supports skin guard pieces 321 (that is, an example of the skin guard part) are moved upward.

Specifically, controller 55 moves upward spring pedestal 512 (that is, an example of the reception part, here, a member on which the piece is supported) that receives outer blade pieces 311 (that is, the outer blade), and second controller 65 moves upward second spring pedestal 612 (that is, the second reception part, here, the member on which the piece is supported) that receives skin guard pieces 321 (that is, an example of the skin guard part).

For example, when the load applied to outer blade pieces 311 (that is, the outer blade) respectively detected by five sensors 53 and the load applied to skin guard pieces 321 (that is, an example of the skin guard part) respectively detected by two second sensors 63 have values shown in FIG. 9, the load applied to outer blade pieces 311 (that is, the outer blade) at both ends is 0.6N, that is, a value exceeding 0.5N (that is, an example of a preset value).

Therefore, when the value illustrated in FIG. 9 is detected, in step S33, controller 55 moves upward spring pedestal 512 (that is, an example of the reception part, here, a member on which the piece is supported) that supports outer blade pieces 311 (that is, the outer blade), and second controller 65 moves upward second spring pedestal 612 (that is, the second reception part, here, the member on which the piece is supported) that supports skin guard pieces 321 (that is, an example of the skin guard part). At this time, controller 55 controls the upward movement amount of spring pedestal 512 (that is, an example of the reception part, here, a member on which the piece is supported), and second controller 65 controls the upward movement amount of second spring pedestal 612 (that is, the second reception part, here, the member on which the piece is supported) so as to be in the state illustrated in FIG. 10. That is, until the load of each of outer blade pieces 311 (that is, the outer blade) at both ends becomes less than or equal to 0.5N (that is, an example of a preset value), controller 55 controls the upward movement amount of spring pedestal 512 (that is, an example of the reception part, here, a member on which the piece is supported), and second controller 65 controls the upward movement amount of second spring pedestal 612 (that is, the second reception part, here, the member on which the piece is supported). In the state illustrated in FIG. 10, the load of each of two skin guard pieces 321 (that is, an example of the skin guard part) is 1.25N. This load of 1.25N is a load different from the load applied to outer blade pieces 311.

Then, when the movement of spring pedestal 512 (that is, an example of the reception part, here, a member on which the piece is supported) by controller 55 and the movement of second spring pedestal 612 (that is, the second reception part, here, the member on which the piece is supported) by second controller 65 are completed, the process returns to step S31.

On the other hand, when “NO” is determined in step S32, the process proceeds to step S34. That is, controller 55 does not allow the spring pedestal 512 (that is, an example of the reception part, here, a member on which the piece is supported) to move, and second controller 65 does not allow second spring pedestal 612 (that is, the second reception part, here, the member on which the piece is supported) to move.

If “NO” is determined in step S32 and the process proceeds to step S34, the process returns to step S31 without moving spring pedestal 512 (that is, an example of the reception part, here, a member on which the piece is supported) and second spring pedestal 612 (that is, the second reception part, here, the member on which the piece is supported).

When electric shaver 1 is in a state capable of shaving, the control in steps S31, S32, and S33 or the control in steps S31, S32, and S34 are repeatedly performed.

By performing such control, the pressing force from skin S can also be dispersed to skin guard piece 321 (that is, an example of the skin guard part), so that the load per one outer blade piece 311 (that is, the outer blade) can be further reduced. As a result, shaving can be performed (that is, electric shaver 1 is used) while reducing the burden on skin S more reliably.

In the control shown in FIG. 8, second controller 65 controls the movement amount of second spring pedestal 612 (that is, an example of the second reception part, here, the member on which the piece is supported) in vertical direction Z (that is, an example of the term “in one direction”) so that the load applied to skin guard pieces 321 (that is, an example of the skin guard part) and the load applied to outer blade pieces 311 (that is, the outer blade) are different.

At this time, as shown in FIG. 10, if the load applied to skin guard pieces 321 (that is, an example of the skin guard part) is made larger than the load applied to outer blade pieces 311 (that is, the outer blade), the load per one outer blade piece 311 (that is, the outer blade) can be further reduced. Therefore, shaving can be performed (that is, electric shaver 1 is used) while reducing the burden on skin S more reliably.

On the other hand, if the load applied to skin guard pieces 321 (that is, an example of the skin guard part) is made smaller than the load applied to outer blade pieces 311 (that is, the outer blade), the load per one outer blade piece 311 (that is, the outer blade) can be increased. As a result, the adhesion of outer blade pieces 311 (that is, the outer blade) to skin S is enhanced, and shaving can be performed (that is, electric shaver 1 is used) while performing deeper shaving.

In a case where blade unit 3 includes blade block 31 but does not include skin guard block 32, the control illustrated in FIG. 8 can be performed. In this case, in step S31, sensor 53 detects a load applied to outer blade pieces 311 (that is, the outer blade).

In step S33, spring pedestal 512 (that is, an example of the reception part, here, a member on which the piece is supported) is moved upward, and in step S34, spring pedestal 512 (that is, an example of the reception part, here, a member on which the piece is supported) is not allowed to move.

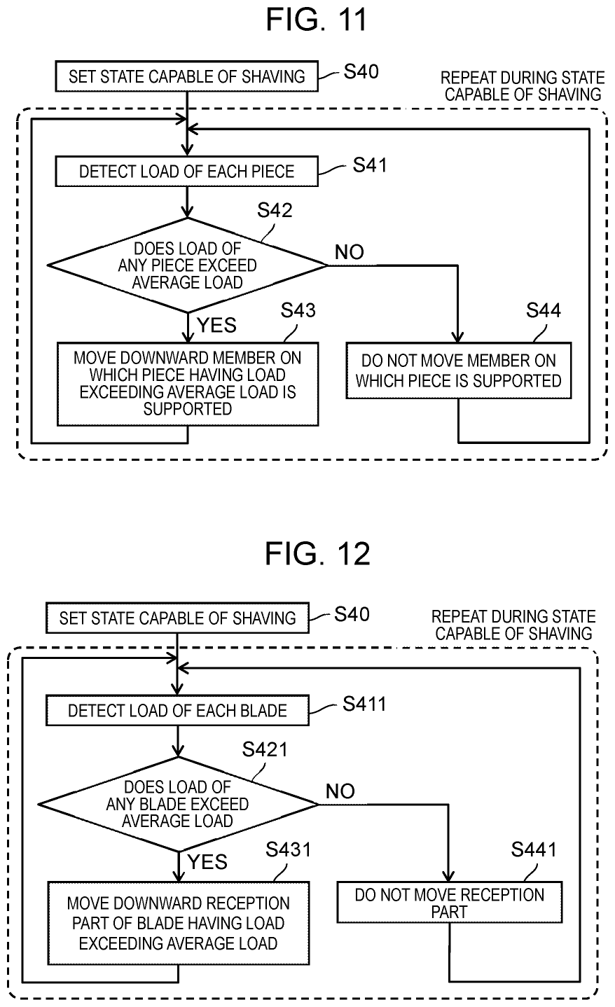

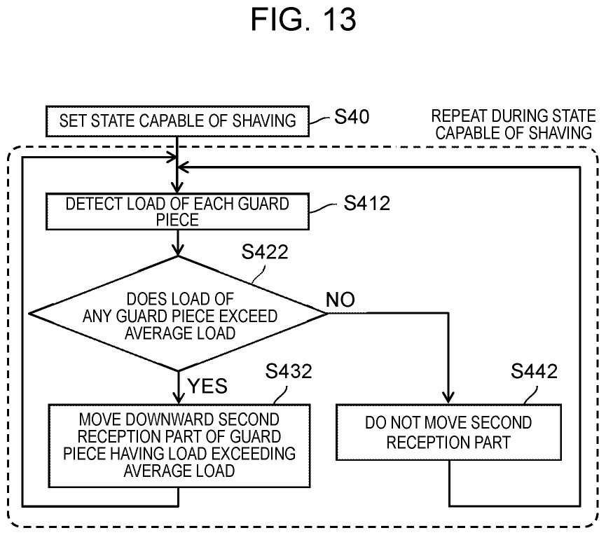

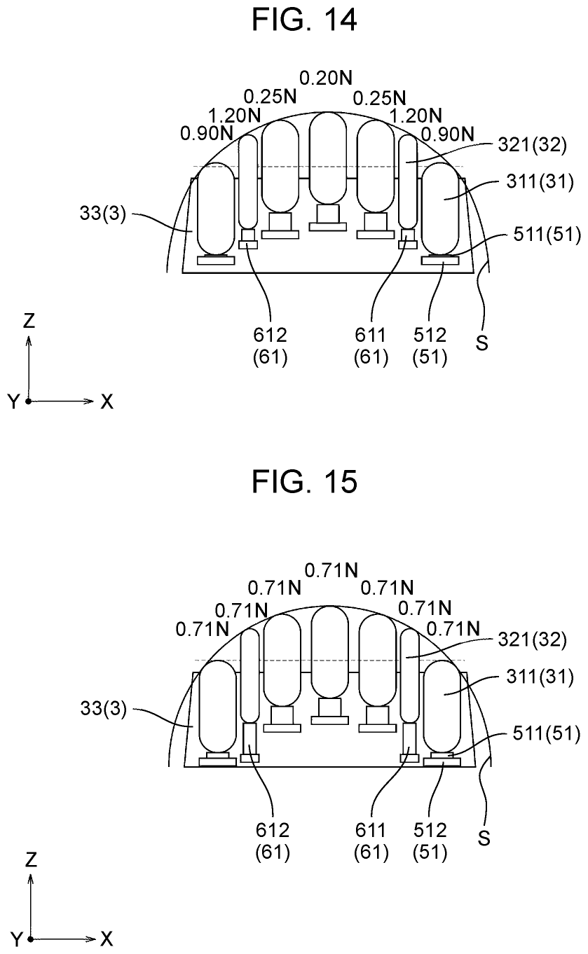

Furthermore, in a case where blade unit 3 includes five blade blocks 31 and two skin guard blocks 32, the load applied to outer blade pieces 311 (that is, the outer blade) can be controlled by a method as illustrated in FIG. 11. Hereinafter, specific contents of the control illustrated in FIG. 11 will be described with reference to FIGS. 12 to 15. FIG. 11 is a flowchart illustrating a control method using load adjustment mechanism 5 and second load adjustment mechanism 6 according to the exemplary embodiment, and is a flowchart illustrating a fourth control method. FIG. 12 is a flowchart showing an example of a method of controlling the outer blade in a case where the fourth control method is performed. FIG. 13 is a flowchart illustrating an example of a method of controlling the skin guard part when the fourth control method is performed. FIG. 14 is a view for explaining the movement of the reception part and the second reception part when the control by the fourth control method is performed, and is a side view schematically showing the positions of the reception part and the second reception part in a state where the pressing force of any one piece exceeds a predetermined value. FIG. 15 is a view for explaining the movement of the reception part and the second reception part when the control is performed by the fourth control method, and is a side view schematically illustrating the positions of the reception part and the second reception part in a state where the pressing force of all the pieces becomes a predetermined value.

First, electric shaver 1 is brought into a state capable of shaving (step S40).

Specifically, electric shaver 1 is powered on so that shaving can be performed.

Next, the load of each piece is detected by the sensor. Specifically, sensor 53 detects a load applied to outer blade pieces 311 (that is, the outer blade) (step S41: step S411 in FIG. 12). In addition, second sensor 63 detects a load applied to skin guard pieces 321 (that is, an example of the skin guard part) (step S41: step S412 in FIG. 13).

Specifically, five sensors 53 detect loads applied to corresponding outer blade pieces 311 (that is, the outer blade), and two second sensors 63 detect loads applied to corresponding skin guard pieces 321 (that is, an example of the skin guard part). Then, an average load (that is, total load/number of pieces) is calculated based on the load applied to outer blade pieces 311 (that is, the outer blade) detected by sensors 53 and the load applied to skin guard pieces 321 (that is, an example of the skin guard part) detected by second sensors 63. That is, the total of respective loads (that is, the total load) applied to outer blade pieces 311 (that is, the outer blade) detected by sensor 53 and respective loads applied to skin guard pieces 321 (that is, an example of the skin guard part) detected by second sensor 63 is calculated, and the average load (that is, total load/number of pieces) is calculated by dividing the calculated total load by the number of pieces.

Next, it is determined whether or not the load applied to any one of outer blade pieces 311 (that is, the outer blade) and skin guard pieces 321 (that is, an example of the skin guard part) exceeds the calculated average load (that is, the total load applied to respective pieces/the number of pieces) (step S42).

Specifically, it is determined whether or not the load applied to any one of five outer blade pieces 311 (that is, the outer blade) exceeds an average load (that is, the total load applied to respective pieces/the number of pieces) (step S421 in FIG. 12). In addition, it is determined whether or not the load applied to any one of two skin guard pieces 321 (that is, an example of the skin guard part) exceeds the average load (that is, total of loads applied to respective pieces/the number of pieces) (step S422 in FIG. 13). As described above, in step S42, it is determined whether or not any of the loads applied to outer blade pieces 311 (that is, the outer blade) respectively detected by five sensors 53 exceeds the average load (here, total of loads of seven pieces/seven). In addition, it is determined whether or not any of the loads applied to skin guard pieces 321 (that is, an example of the skin guard part) respectively detected by two second sensors 63 exceeds the average load (here, total of loads of seven pieces/seven).

When “YES” is determined in step S42, the process proceeds to step S43. That is, the member on which the piece having a load exceeding the average load (that is, total of loads applied to respective pieces/the number of pieces) is supported is moved downward. Specifically, when outer blade pieces 311 (that is, the outer blade) having a load exceeding the average load (that is, total of loads applied to respective pieces/the number of pieces) are present, controller 55 moves downward spring pedestal 512 (that is, an example of the reception part, here, a member on which the piece is supported) on which outer blade pieces 311 (that is, the outer blade) having a load exceeding the average load (that is, total of loads applied to respective pieces/the number of pieces) are supported (step S431 in FIG. 12). When skin guard pieces 321 (that is, an example of the skin guard part) having the load exceeding the average load (that is, total of loads applied to respective pieces/the number of pieces) is present, second controller 65 moves downward second spring pedestal 612 (that is, the second reception part, here, the member on which the piece is supported) on which skin guard pieces 321 (that is, an example of the skin guard part) having the load exceeding the average load (that is, total of loads applied to respective pieces/the number of pieces) are supported (step S432 in FIG. 13).

For example, when the load applied to outer blade pieces 311 (that is, the outer blade) respectively detected by five sensors 53 and the load applied to skin guard pieces 321 (that is, an example of the skin guard part) respectively detected by two second sensors 63 have values illustrated in FIG. 14, total of loads (that is, the total load) of the seven pieces is 5.0N. The load applied to outer blade pieces 311 (that is, the outer blade) at both ends is 0.9N, that is, a value exceeding the average load (here, total of loads of the seven pieces/seven). On the other hand, the load applied to three outer blade pieces 311 at the center (that is, the outer blade) is less than the average load (here, total of loads of the seven pieces/seven).

Therefore, when the value shown in FIG. 14 is detected, in step S431, controller 55 moves downward spring pedestal 512 (that is, an example of the reception part, here, a member on which the piece is supported) that support two outer blade pieces 311 (that is, the outer blade) at both ends. At this time, controller 55 controls the downward movement amount of two spring pedestals 512 (that is, an example of the reception part, here, a member on which the piece is supported) at both ends so as to be in the state illustrated in FIG. 15. Specifically, controller 55 controls the downward movement amount of two spring pedestals 512 (that is, an example of the reception part, here, a member on which the piece is supported) at both ends such that the load of each of five outer blade pieces 311 (that is, the outer blade) becomes about 0.71N, that is, equivalent to the average load (here, total of loads of the seven pieces/seven).

The load applied to two skin guard pieces 321 (that is, an example of the skin guard part) is 1.2N, that is, a value exceeding the average load (here, total of loads of the seven pieces/seven).

Therefore, when the value illustrated in FIG. 14 is detected, in step S432, second controller 65 moves downward second spring pedestal 612 (that is, the second reception part, here, the member on which the piece is supported) that supports two skin guard pieces 321 (that is, an example of the skin guard part). At this time, second controller 65 controls the downward movement amount of two second spring pedestals 612 (that is, the second reception part, here, the member on which the piece is supported) so as to be in the state illustrated in FIG. 15. Specifically, second controller 65 controls the downward movement amount of two second spring pedestals 612 (that is, the second reception part, here, the member on which the piece is supported) such that the load of each of two skin guard pieces 321 (that is, an example of the skin guard part) becomes about 0.71N, that is, equivalent to the average load (here, total of loads of the seven pieces/seven).

When the movement of the spring pedestal 512 (that is, an example of the reception part, here, a member on which the piece is supported) by controller 55 and the movement of second spring pedestal 612 (that is, the second reception part, here, the member on which the piece is supported) by second controller 65 are completed, the process returns to step S41 (Step S411, Step S412).

On the other hand, when “NO” is determined in step S42 (Step S421, Step S422), the process proceeds to step S44 (Step S441, Step S442). That is, all the members on which the pieces are supported are not allowed to move. Specifically, the movement of spring pedestal 512 (that is, an example of the reception part, here, a member on which the piece is supported) by controller 55 and the movement of second spring pedestal 612 (that is, the second reception part, here, the member on which the piece is supported) by second controller 65 are prevented.

If “NO” is determined in step S42 (Step S421, Step S422) and the process proceeds to step S44 (Step S441, Step S442), the process returns to step S41 (Step S411, Step S412) without moving spring pedestal 512 (that is, an example of the reception part, here, a member on which the piece is supported) and second spring pedestal 612 (that is, the second reception part, here, the member on which the piece is supported).

When electric shaver 1 is in a state capable of shaving, the control in steps S41, S42, and S43 or the control in steps S41, S42, and S44 are repeatedly performed. That is, the control in steps S411, S421, and S431 or the control in steps S411, S421, and S441 are repeatedly performed, and the control in steps S412, S422, and S432 or the control in steps S412, S422, and S442 are repeatedly performed.

Such control enables shaving to be performed (that is, electric shaver 1 is used) while reducing the burden on skin S more reliably.

Further, since the load applied to skin guard pieces 321 (that is, an example of the skin guard part) and the load applied to outer blade pieces 311 (that is, the outer blade) are substantially equal to each other, each piece (that is, outer blade piece 311 and skin guard piece 321) is more evenly pressed against skin S, so that it is possible to improve skin contact when shaving is performed (that is, when electric shaver 1 is used).

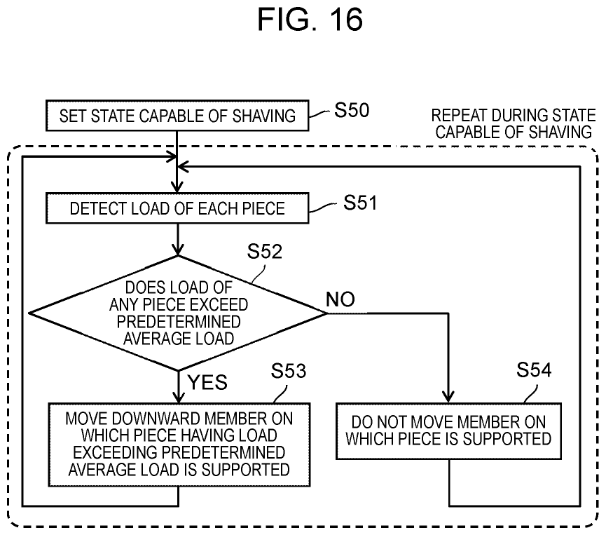

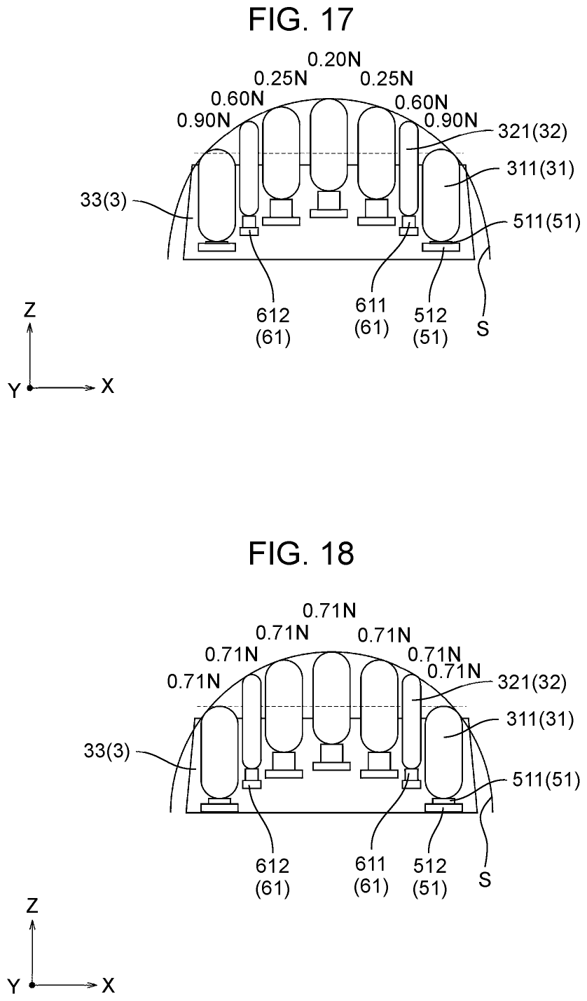

Furthermore, in a case where blade unit 3 includes five blade blocks 31 and two skin guard blocks 32, the load applied to outer blade pieces 311 (that is, the outer blade) can be controlled by a method as illustrated in FIG. 16. Hereinafter, specific contents of the control illustrated in FIG. 16 will be described with reference to FIGS. 17 and 18. FIG. 16 is a flowchart illustrating a control method using load adjustment mechanism 5 and second load adjustment mechanism 6 according to the exemplary embodiment, and is a flowchart illustrating a fifth control method. FIG. 17 is a view for explaining the movement of the reception part and the second reception part when the control by the fifth control method is performed, and is a side view schematically illustrating the positions of the reception part and the second reception part in a state where the pressing force of any one piece exceeds a predetermined value. FIG. 18 is a view for explaining the movement of the reception part and the second reception part when the control by the fifth control method is performed, and is a side view schematically illustrating a state in which the reception part of the piece having a predetermined value or more is moved downward.

First, electric shaver 1 is brought into a state capable of shaving (step S50).

Specifically, electric shaver 1 is powered on so that shaving can be performed.

Next, the load of each piece is detected by the sensor (step S51).

Specifically, five sensors 53 detect loads applied to corresponding outer blade pieces 311 (that is, the outer blade), and two second sensors 63 detect loads applied to corresponding skin guard pieces 321 (that is, an example of the skin guard part).

Next, it is determined whether or not the pressing force of any one of outer blade pieces 311 (that is, the outer blade) and skin guard pieces 321 (that is, an example of the skin guard part) exceeds a predetermined average load (that is, the preset load/number of pieces) (step S52).

Specifically, it is determined whether or not a load applied to any one of five outer blade pieces 311 (that is, the outer blade) exceeds a predetermined average load (that is, the preset load/number of pieces). In addition, it is determined whether or not a load applied to any one of two skin guard pieces 321 (that is, an example of the skin guard part) exceeds a predetermined average load (that is, the preset load/number of pieces).

When “YES” is determined in step S52, the process proceeds to step S53. That is, the member on which the piece having a load exceeding the predetermined average load (that is, the preset load/number of pieces) is supported is moved downward. Specifically, spring pedestal 512 (that is, an example of the reception part, here, a member on which the piece is supported) that supports outer blade pieces 311 (that is, the outer blade) having a load exceeding a predetermined average load (that is, the preset load/number of pieces) is moved downward. In addition, second spring pedestal 612 (that is, the second reception part, here, the member on which the piece is supported) that supports skin guard pieces 321 (that is, an example of the skin guard part) having a load exceeding the predetermined average load (that is, the preset load/number of pieces) is moved downward.

For example, when the preset load is 5.0N, if the load applied to outer blade pieces 311 (that is, the outer blade) detected by corresponding five sensors 53 and the load applied to skin guard pieces 321 (that is, an example of the skin guard part) detected by corresponding two second sensors 63 have values shown in FIG. 17, the load applied to outer blade pieces 311 (that is, the outer blade) at both ends is 0.9N, that is, a value exceeding a predetermined average load (here, 5.0/7). On the other hand, the load applied to three outer blade pieces 311 at the center (that is, the outer blade) is less than a predetermined average load (here, 5.0/7).

Therefore, when the value shown in FIG. 17 is detected, in step S53, controller 55 moves downward spring pedestal 512 (that is, an example of the reception part, here, a member on which the piece is supported) that supports two outer blade pieces 311 (that is, the outer blade) at both ends. At this time, controller 55 controls the downward movement amount of two spring pedestals 512 (that is, an example of the reception part, here, a member on which the piece is supported) at both ends so as to be in the state illustrated in FIG. 18. Specifically, controller 55 controls the downward movement amount of two spring receiving pedestals 512 (that is, an example of the reception part, here, a member on which the piece is supported) at both ends such that the load of each of five outer blade pieces 311 (that is, the outer blade) is about 0.71N, that is, equivalent to a predetermined average load (here, 5.0/7).

The load applied to two skin guard pieces 321 (that is, an example of the skin guard part) is 0.6N, that is, a value less than a predetermined average load (here, 5.0/7).

Therefore, when the value illustrated in FIG. 17 is detected, in step S53, second controller 65 does not allow second spring pedestal 612 (that is, the second reception part, here, the member on which the piece is supported) that supports two skin guard pieces 321 (that is, an example of the skin guard part) to move.

Then, when the movement of spring pedestal 512 (that is, an example of the reception part, here, a member on which the piece is supported) by controller 55 and the movement of second spring pedestal 612 (that is, the second reception part, here, the member on which the piece is supported) by second controller 65 are completed, the process returns to step S51.

When “NO” is determined in step S52, the process proceeds to step S54. That is, all the members on which the pieces are supported are not allowed to move. Specifically, the movement of spring pedestal 512 (that is, an example of the reception part, here, a member on which the piece is supported) by controller 55 and the movement of second spring pedestal 612 (that is, the second reception part, here, the member on which the piece is supported) by second controller 65 are prevented.

If “NO” is determined in step S52 and the process proceeds to step S54, the process returns to step S51 without moving spring pedestal 512 (that is, an example of the reception part, here, a member on which the piece is supported) and the second spring pedestal 612 (that is to say, the second reception part, here, the member on which the piece is supported).

When electric shaver 1 is in a state capable of shaving, the control in steps S51, S52, and S53 or the control in steps S51, S52, and S54 are repeatedly performed.

If such control is performed, controller 55 and second controller 65 control outer blade pieces 311 (that is, the outer blade) and skin guard pieces 321 (that is, an example of the skin guard part) each having a load larger than a predetermined average load so that the total of loads (that is, the total load) of the loads applied to outer blade pieces 311 (that is, the outer blade) and skin guard pieces 321 (that is, an example of the skin guard part) becomes a preset load. Therefore, during shaving (that is, when electric shaver 1 is in use), the pressing force to skin S by all outer blade pieces 311 (that is, the outer blade) and all skin guard pieces 321 (that is, an example of the skin guard part) can be set to a target pressing force (here, a predetermined load), and the pressing force to skin S of each piece can be set to a more uniform pressing force (here, a predetermined average load, more specifically, a preset load/number of pieces). As a result, during shaving (that is, when electric shaver 1 is in use), it is possible to prevent each piece (that is, outer blade piece 311 and skin guard piece 321) from being pressed against skin S too strongly or to prevent pressing force of each piece (that is, outer blade piece 311 and skin guard piece 321) against skin S from becoming too weak. Therefore, since each piece (that is, outer blade piece 311 and skin guard piece 321) can be pressed against skin S with a more appropriate pressing force (more specifically, a target pressing force), it is possible to reduce a burden on skin S while suppressing a decrease in cutting efficiency of the whisker (that is, one example of body hair) during shaving (that is, when electric shaver 1 is in use). That is, it is possible to more efficiently and more reliably cut the whisker (that is, one example of body hair).

In particular, as in a case where the loads have values illustrated in FIG. 17, when the total load of the pressing forces (that is, the pressing load) against skin S of each piece during shaving (that is, when electric shaver 1 is in use) is smaller than a preset load, the number of pieces having a load larger than the target pressing force (here, a predetermined average load, more specifically, a preset load/number of pieces) may be reduced.

Therefore, in such a case, by controlling outer blade pieces 311 (that is, the outer blade) having a load larger than a predetermined average load, the number of outer blade pieces 311 (that is, the outer blade) to be controlled can be reduced.

Also in a case where electric shaver 1 includes a large number of pieces, the number of pieces having a pressing force larger than a target load (here, a predetermined average load, more specifically, a preset load/number of pieces) is often smaller than the number of pieces having a pressing force smaller than a target load (here, a predetermined average load, more specifically, a preset load/number of pieces). Therefore, by controlling pieces having a load larger than a predetermined average load, the number of pieces to be controlled can be reduced.

In this way, by controlling the piece having a load larger than the predetermined average load so that the total load applied to the piece becomes a preset load, it becomes possible to perform shaving (that is, to use electric shaver 1) while reducing the load on skin S by controlling the smaller number of pieces.

In a case where blade unit 3 includes blade block 31 but does not include skin guard block 32, the control illustrated in FIG. 16 can be also performed. In this case, in step S51, sensor 53 detects a load applied to outer blade pieces 311 (that is, the outer blade).

In step S52, it is determined whether or not the load applied to any one of outer blade pieces 311 (that is, the outer blade) exceeds a predetermined average load (preset load/number of blades).

Further, in step S53, spring pedestal 512 (that is, an example of the reception part, here, a member on which the piece is supported) that supports outer blade pieces 311 (that is, the outer blade) having a load exceeding a predetermined average load (a preset load/number of blades) is moved downward, and in step S54, spring pedestal 512 (that is, an example of the reception part, here, a member on which the piece is supported) is not allowed to move.

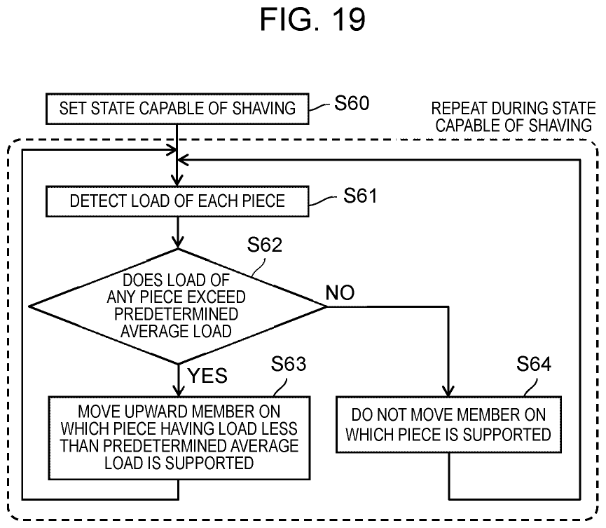

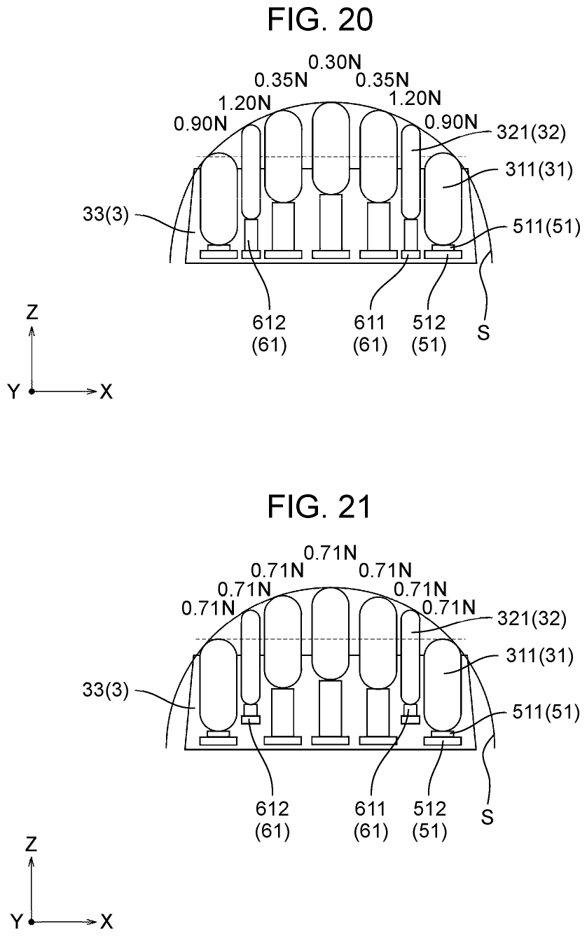

Furthermore, in a case where blade unit 3 includes five blade blocks 31 and two skin guard blocks 32, the load applied to outer blade pieces 311 (that is, the outer blade) can be also controlled by a method as illustrated in FIG. 19. Hereinafter, specific contents of the control illustrated in FIG. 19 will be described with reference to FIGS. 20 and 21. FIG. 19 is a flowchart illustrating a control method using load adjustment mechanism 5 and second load adjustment mechanism 6 according to the exemplary embodiment, and is a flowchart illustrating a sixth control method. FIG. 20 is a view for explaining the movement of the reception part and the second reception part when the control by the sixth control method is performed, and is a side view schematically illustrating the positions of the reception part and the second reception part in a state where the pressing force of any one piece exceeds a predetermined value. FIG. 21 is a view for explaining the movement of the reception part and the second reception part when the control by the sixth control method is performed, and is a side view schematically illustrating a state in which the reception part and the second reception part of the piece less than the predetermined value are moved upward.

First, electric shaver 1 is brought into a state capable of shaving (step S60).

Specifically, electric shaver 1 is powered on so that shaving can be performed.

Next, the load of each piece is detected by the sensor (step S61).

Specifically, five sensors 53 detect loads applied to corresponding outer blade pieces 311 (that is, the outer blade), and two second sensors 63 detect loads applied to corresponding skin guard pieces 321 (that is, an example of the skin guard part).

Next, it is determined whether or not a load applied to any one of outer blade pieces 311 (that is, the outer blade) and skin guard pieces 321 (that is, an example of the skin guard part) exceeds a predetermined average load (that is, the preset load/number of pieces) (step S62).

Specifically, it is determined whether or not a load applied to any one of five outer blade pieces 311 (that is, the outer blade) exceeds a predetermined average load (that is, the preset load/number of pieces). In addition, it is determined whether or not a load applied to any one of two skin guard pieces 321 (that is, an example of the skin guard part) exceeds a predetermined average load (that is, the preset load/number of pieces).

When “YES” is determined in step S62, the process proceeds to step S63. That is, the member on which the piece having a load less than the predetermined average load (that is, the preset load/number of pieces) is supported is moved upward. Specifically, spring pedestal 512 (that is, an example of the reception part, here, a member on which the piece is supported) that supports outer blade pieces 311 (that is, the outer blade) having a load less than a predetermined average load (that is, the preset load/number of pieces) is moved upward. In addition, second spring pedestal 612 (that is, the second reception part, here, the member on which the piece is supported) that supports skin guard pieces 321 (that is, an example of the skin guard part) having a load less than the predetermined average load (that is, the preset load/number of pieces) is moved upward.

For example, when the preset load is 5.0N, if the load applied to outer blade pieces 311 (that is, the outer blade) detected by corresponding five sensors 53 and the load applied to skin guard pieces 321 (that is, an example of the skin guard part) detected by corresponding two second sensors 63 have values shown in FIG. 20, the load applied to outer blade pieces 311 (that is, the outer blade) at both ends is 0.9N, that is, a value exceeding a predetermined average load (here, 5.0/7). On the other hand, the load applied to three outer blade pieces 311 at the center (that is, the outer blade) is less than a predetermined average load (here, 5.0/7).

Therefore, when the value shown in FIG. 20 is detected, in step S63, controller 55 moves upward spring pedestal 512 (that is, an example of the reception part, here, a member on which the piece is supported) that supports three outer blade pieces 311 at the center (that is, the outer blade). At this time, controller 55 controls the upward movement amount of three spring pedestals 512 (that is, an example of the reception part, here, a member on which the piece is supported) at the center so as to be in the state illustrated in FIG. 21. Specifically, controller 55 controls the upward movement amount of three spring pedestals 512 (that is, an example of the reception part, here, a member on which the piece is supported) such that the load of each of five outer blade pieces 311 (that is, the outer blade) is about 0.71N, that is, equivalent to a predetermined average load (here, 5.0/7).

The load applied to two skin guard pieces 321 (that is, an example of the skin guard part) is 1.2N, that is, a value more than or equal to a predetermined average load (here, 5.0/7).

Therefore, when the value illustrated in FIG. 20 is detected, in step S63, second controller 65 does not allow second spring pedestal 612 (that is, the second reception part, here, the member on which the piece is supported) that supports two skin guard pieces 321 (that is, an example of the skin guard part) to move.

Then, when the movement of spring pedestal 512 (that is, an example of the reception part, here, a member on which the piece is supported) by controller 55 and the movement of second spring pedestal 612 (that is, the second reception part, here, the member on which the piece is supported) by second controller 65 are completed, the process returns to step S61.

On the other hand, when “NO” is determined in step S62, the process proceeds to step S64. That is, all the members on which the pieces are supported are not allowed to move. Specifically, the movement of spring pedestal 512 (that is, an example of the reception part, here, a member on which the piece is supported) by controller 55 and the movement of second spring pedestal 612 (that is, the second reception part, here, the member on which the piece is supported) by second controller 65 are prevented.

If “NO” is determined in step S62 and the process proceeds to step S64, the process returns to step S61 without moving spring pedestal 512 (that is, an example of the reception part, here, a member on which the piece is supported) and second spring pedestal 612 (that is, the second reception part, here, the member on which the piece is supported).

When electric shaver 1 is in a state capable of shaving, the control in steps S61, S62, and S63 or the control in steps S61, S62, and S64 are repeatedly performed.

If such control is performed, controller 55 and second controller 65 control outer blade pieces 311 (that is, the outer blade) and skin guard pieces 321 (that is, an example of the skin guard part) having a load smaller than a predetermined average load so that the sum of loads applied to outer blade pieces 311 (that is, the outer blade) and skin guard pieces 321 (that is, an example of the skin guard part) becomes a preset load. Therefore, during shaving (that is, when electric shaver 1 is in use), the pressing force against skin S by all outer blade pieces 311 (that is, the outer blade) and all skin guard pieces 321 (that is, an example of the skin guard part) can be set to a target pressing force (here, a predetermined load), and the pressing force of each piece can be set to a more uniform pressing force (here, a predetermined average load, more specifically, a preset load/number of pieces). As a result, during shaving (that is, when electric shaver 1 is in use), it is possible to prevent each piece (that is, outer blade piece 311 and skin guard piece 321) from being pressed against skin S too strongly or to prevent pressing force of each piece (that is, outer blade piece 311 and skin guard piece 321) against skin S from becoming too weak. Therefore, since each piece (that is, outer blade piece 311 and skin guard piece 321) can be pressed against skin S with a more appropriate pressing force (more specifically, a target pressing force), it is possible to reduce a burden on skin S while suppressing a decrease in cutting efficiency of the whisker (that is, one example of body hair) during shaving (that is, when electric shaver 1 is in use). That is, it is possible to more efficiently and more reliably cut the whisker (that is, one example of body hair).

In particular, as in a case where the loads have values illustrated in FIG. 20, when the total load of the pressing forces (that is, the pressing load) against skin S of each piece during shaving (that is, when electric shaver 1 is in use) is larger than the preset load, the number of pieces having a load smaller than the target pressing force (here, a predetermined average load, more specifically, a preset load/number of pieces) may be reduced.

Therefore, in such a case, by controlling outer blade pieces 311 (that is, the outer blade) having a load smaller than a predetermined average load, it is possible to reduce the number of outer blade pieces 311 (that is, the outer blade) to be controlled.

In addition, even when electric shaver 1 includes a small number of pieces, the number of pieces having a pressing force smaller than a target load (here, a predetermined average load, more specifically, a preset load/number of pieces) is often smaller than the number of pieces having a pressing force larger than a target load (here, a predetermined average load, more specifically, a preset load/number of pieces). Therefore, by controlling pieces having a load smaller than a predetermined average load, it is possible to reduce the number of pieces to be controlled.

In this manner, by controlling the piece having a load smaller than the predetermined average load so that the total load applied to the pieces becomes a preset load, it is possible to perform shaving (that is, to use electric shaver 1) while reducing the load on skin S by controlling the smaller number of pieces.

In a case where blade unit 3 includes blade block 31 but does not include skin guard block 32, the control illustrated in FIG. 19 can be also performed. In this case, in step S61, sensor 53 detects a load applied to outer blade pieces 311 (that is, the outer blade).

In step S62, it is determined whether or not the load applied to any one of outer blade pieces 311 (that is, the outer blade) exceeds a predetermined average load (preset load/number of blades).

Further, in step S63, spring pedestal 512 (that is, an example of the reception part, here, a member on which the piece is supported) that supports outer blade pieces 311 (that is, the outer blade) having a load less than a predetermined average load (the preset load/number of blades) is moved upward, and in step S64, spring pedestal 512 (that is, an example of the reception part, here, a member on which the piece is supported) is not allowed to move.

Further, controller 55 may control outer blade pieces 311 (that is, the outer blade) such that a load applied to outer blade pieces 311 (that is, the outer blade) becomes a preset set load. Electric shaver 1 may be configured to change a set load. At this time, the set load may be changed stepwise within a predetermined range, or may be continuously changed within a predetermined range.

When blade unit 3 includes blade block 31 and skin guard block 32, controller 55 and second controller 65 control outer blade pieces 311 (that is, the outer blade) and skin guard pieces 321 (that is, an example of the skin guard part) so that loads applied to outer blade pieces 311 (that is, the outer blade) and skin guard pieces 321 (that is, an example of the skin guard part) become set loads (as one example, a set load selected by a user or the like). Electric shaver 1 is configured such that the entire pressing force applied to skin S by all outer blade pieces 311 (that is, the outer blade) and all skin guard pieces 321 (that is, an example of the skin guard part) can be changed to a desired pressing force (that is, the target set load).

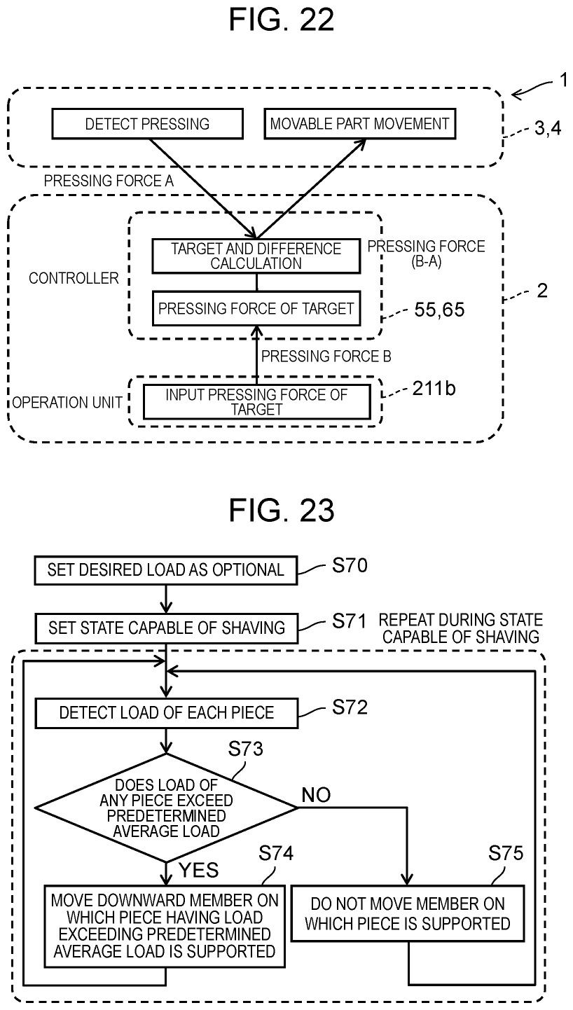

For example, as illustrated in FIG. 22, electric shaver 1 can be obtained by providing operation unit 211b such as a load setting switch in main body housing 211 (that is, one element of shaver body 2), and operating operation unit 211b to store desired pressing force (that is, the target set load) in controller 55 or the like. FIG. 22 is a block diagram illustrating a function of electric shaver 1 according to a first modification.

Then, at the time of performing shaving (that is, when electric shaver 1 is used), it is possible to perform control to calculate a difference from a target set load by comparing a desired pressing force (that is, the target set load) stored in controller 55 or the like and a sum of loads applied to all pieces (that is, outer blade pieces 311 and skin guard pieces 321) detected by sensor 53 and second sensor 63. For example, in a case where the sum of loads applied to all the pieces (that is, outer blade pieces 311 and skin guard pieces 321) is A and the target set load is B, it is possible to perform control so as to calculate B-A. Then, based on the calculation result B-A, target spring pedestal 512 (that is, an example of the reception part, here, a member on which the piece is supported) and target second spring pedestal 612 (that is, the second reception part, here, the member on which the piece is supported) are moved, and control can be performed such that the sum of loads applied to all the pieces (that is, outer blade pieces 311 and skin guard pieces 321) detected by sensor 53 and second sensor 63 becomes B. This enables shaving (that is, to use electric shaver 1) with a target set load B.

Specifically, the load applied to outer blade pieces 311 (that is, the outer blade) and skin guard pieces 321 (that is, an example of the skin guard part) can be controlled by a method as illustrated in FIG. 23. FIG. 23 is a flowchart illustrating a control method using load adjustment mechanism 5 included in electric shaver 1 according to the first modification, and is a flowchart illustrating a seventh control method. Hereinafter, specific contents of the control illustrated in FIG. 23 will be described.

First, a desired load is set as optional (step S70). Specifically, the pressing force (that is, the set load) is set to a desired pressing force by operating operation unit 211b.

Next, electric shaver 1 is brought into a state capable of shaving (step S71).

Specifically, electric shaver 1 is powered on so that shaving can be performed.

Next, the load of each piece is detected by the sensor (step S72).

Specifically, sensor 53 detects a load applied to each of outer blade pieces 311 (that is, the outer blade), and second sensor 63 detects a load applied to each of skin guard pieces 321 (that is, an example of the skin guard part).

Next, it is determined whether or not the pressing force of any one of outer blade pieces 311 (that is, the outer blade) and skin guard pieces 321 (that is, an example of the skin guard part) exceeds a predetermined average load (that is, the set load/number of pieces) (step S73).

When “YES” is determined in step S73, the process proceeds to step S74. That is, the member on which the piece having a load exceeding the predetermined average load (that is, the set load/number of pieces) is supported is moved downward. Specifically, spring pedestal 512 (that is, an example of the reception part, here, a member on which the piece is supported) that supports outer blade pieces 311 (that is, the outer blade) having a load exceeding a predetermined average load (that is, the preset load/number of pieces) is moved downward. In addition, second spring pedestal 612 (that is, the second reception part, here, the member on which the piece is supported) that supports skin guard pieces 321 (that is, an example of the skin guard part) having a load exceeding the predetermined average load (that is, the set load/number of pieces) is moved downward.

Then, when the movement of spring pedestal 512 (that is, an example of the reception part, here, a member on which the piece is supported) by controller 55 and the movement of second spring pedestal 612 (that is, the second reception part, here, the member on which the piece is supported) by second controller 65 are completed, the process returns to step S72.

On the other hand, when “NO” is determined in step S73, the process proceeds to step S75. That is, all the members on which the pieces are supported are not allowed to move. Specifically, the movement of spring pedestal 512 (that is, an example of the reception part, here, a member on which the piece is supported) by controller 55 and the movement of second spring pedestal 612 (that is, the second reception part, here, the member on which the piece is supported) by second controller 65 are prevented.

If “NO” is determined in step S73 and the process proceeds to step S75, the process returns to step S72 without moving spring pedestal 512 (that is, an example of the reception part, here, a member on which the piece is supported) and second spring pedestal 612 (that is, the second reception part, here, the member on which the piece is supported).

When electric shaver 1 is in a state capable of shaving, the control in steps S72, S73, and S74 or the control in steps S72, S73, and S75 are repeatedly performed.

By performing such control, each user can set a load (that is, a load suitable for the strength of the skin of the user) according to the strength and preference of each skin, and a personalizable product (For example, electric shaver 1) can be provided.

In the case that the same user uses a product, the setting can be changed according to the tone of skin S during use, so that the product (For example, electric shaver 1) capable of responding to the daily changing state of skin S of the user can be provided.

In a case where blade unit 3 includes blade block 31 but does not include skin guard block 32, the control illustrated in FIG. 23 can be also performed. In this case, in step S72, sensor 53 detects a load applied to outer blade pieces 311 (that is, the outer blade).

In step S73, it is determined whether or not the load applied to any one of outer blade pieces 311 (that is, the outer blade) exceeds a predetermined average load (that is, the set load/number of blades).

In step S74, spring pedestal 512 (that is, an example of the reception part, here, a member on which the piece is supported) that supports outer blade pieces 311 (that is, the outer blade) having a load exceeding a predetermined average load (that is, the set load/number of pieces) is moved downward, and in step S75, spring pedestal 512 (that is, an example of the reception part, here, a member on which the piece is supported) is not allowed to move.

When electric shaver 1 changes the set load, the set load may be changed by remote control. Also in this case, the set load may be changed stepwise within a predetermined range, or may be continuously changed within a predetermined range.

When blade unit 3 includes blade block 31 and skin guard block 32, controller 55 and second controller 65 control outer blade pieces 311 (that is, the outer blade) and skin guard pieces 321 (that is, an example of the skin guard part) so that loads applied to outer blade pieces 311 (that is, the outer blade) and skin guard pieces 321 (that is, an example of the skin guard part) become set loads (As an example, a set load selected by a user or the like). Electric shaver 1 is configured such that the entire pressing force applied to skin S by all outer blade pieces 311 (that is, the outer blade) and all skin guard pieces 321 (that is, an example of the skin guard part) can be changed to a desired pressing force (that is, the target set load).

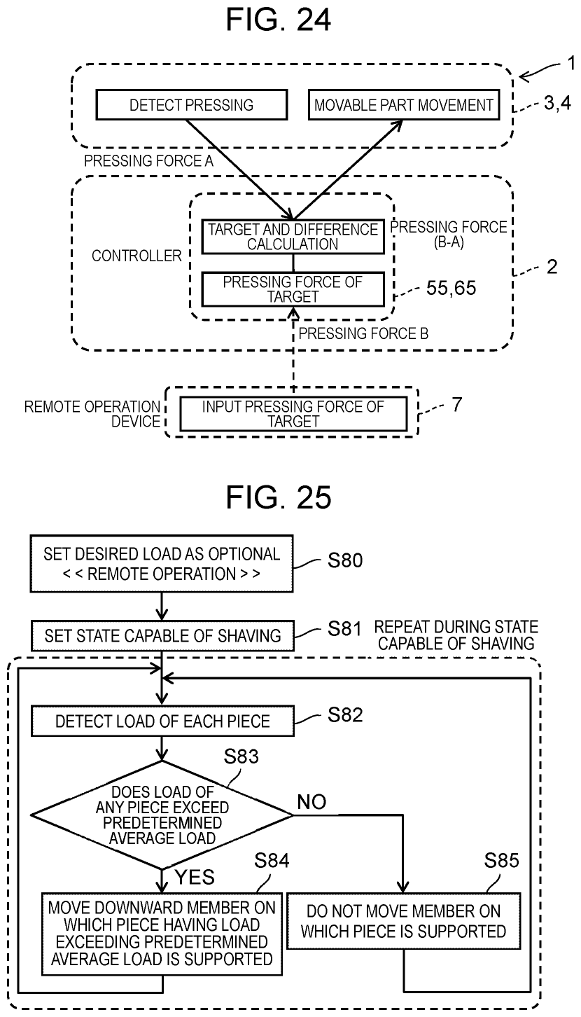

For example, as illustrated in FIG. 24, electric shaver 1 can be obtained by operating remote operation device 7 such as a smartphone to store a desired pressing force (that is, the target set load) in controller 55 or the like. FIG. 24 is a block diagram illustrating a function of electric shaver 1 according to a second modification.

Then, at the time of performing shaving (that is, when electric shaver 1 is used), it is possible to perform control to calculate a difference from a target set load by comparing a desired pressing force (that is, the target set load) stored in controller 55 or the like and a sum of loads applied to all pieces (that is, outer blade pieces 311 and skin guard pieces 321) detected by sensor 53 and second sensor 63. For example, in a case where the sum of loads applied to all the pieces (that is, outer blade pieces 311 and skin guard pieces 321) is A and the target set load is B, it is possible to perform control so as to calculate B-A. Then, based on the calculation result B-A, the target spring pedestal 512 (that is, an example of the reception part) and the target second spring pedestal 612 (that is, an example of the second reception part) are moved, and control can be performed such that the sum of the loads applied to all the pieces (that is, outer blade pieces 311 and skin guard pieces 321) detected by sensor 53 and second sensor 63 becomes B. This enables shaving (that is, to use electric shaver 1) with a target set load B.

Specifically, the load applied to outer blade pieces 311 (that is, the outer blade) and skin guard pieces 321 (that is, an example of the skin guard part) can be controlled by a method as illustrated in FIG. 25. FIG. 25 is a flowchart illustrating a control method using load adjustment mechanism 5 included in electric shaver 1 according to the second modification, and is a flowchart illustrating an eighth control method. Hereinafter, specific contents of the control illustrated in FIG. 25 will be described.

First, the pressing force (that is, the set load) is set to a desired pressing force by operating remote operation device 7 such as a smartphone (step S80).

Next, electric shaver 1 is brought into a state capable of shaving (step S81).

Specifically, electric shaver 1 is powered on so that shaving can be performed.

Next, the load of each piece is detected by the sensor (step S82).

Specifically, sensor 53 detects a load applied to each of outer blade pieces 311 (that is, the outer blade), and second sensor 63 detects a load applied to each of skin guard pieces 321 (that is, an example of the skin guard part).

Next, it is determined whether or not a load applied to any one of outer blade pieces 311 (that is, the outer blade) and skin guard pieces 321 (that is, an example of the skin guard part) exceeds a predetermined average load (that is, the set load/number of pieces) (step S83).

When “YES” is determined in step S83, the process proceeds to step S84. That is, the member on which the piece having a load exceeding the predetermined average load (that is, the set load/number of pieces) is supported is moved downward. Specifically, spring pedestal 512 (that is, an example of the reception part, here, a member on which the piece is supported) that supports outer blade pieces 311 (that is, the outer blade) having a load exceeding a predetermined average load (that is, the preset load/number of pieces) is moved downward. In addition, second spring pedestal 612 (that is, the second reception part, here, the member on which the piece is supported) that supports skin guard pieces 321 (that is, an example of the skin guard part) having a load exceeding the predetermined average load (that is, the set load/number of pieces) is moved downward.

Then, when the movement of spring pedestal 512 (that is, an example of the reception part, here, a member on which the piece is supported) by controller 55 and the movement of second spring pedestal 612 (that is, the second reception part, here, the member on which the piece is supported) by second controller 65 are completed, the process returns to step S82.

When “NO” is determined in step S83, the process proceeds to step S85. That is, all the members on which the pieces are supported are not allowed to move. Specifically, the movement of spring pedestal 512 (that is, an example of the reception part, here, a member on which the piece is supported) by controller 55 and the movement of second spring pedestal 612 (that is, the second reception part, here, the member on which the piece is supported) by second controller 65 are prevented.

If “NO” is determined in step S83 and the process proceeds to step S85, the process returns to step S82 without moving spring pedestal 512 (that is, an example of the reception part, here, a member on which the piece is supported) and second spring pedestal 612 (that is, the second reception part, here, the member on which the piece is supported).

When electric shaver 1 is in a state capable of shaving, the control in steps S82, S83, and S84 or the control in steps S82, S83, and S85 are repeatedly performed.

Also by performing such control, it is possible for each user to set a load (that is, a load suitable for the strength of the skin of the user) according to the strength and preference of each skin, and it is possible to provide a personalizable product (For example, electric shaver 1).

In the case that the same user uses a product, the setting can be changed according to the tone of skin S during use, so that the product (For example, electric shaver 1) capable of responding to the daily changing state of skin S of the user can be provided.

Furthermore, if load setting can be performed using remote operation device 7 such as a smartphone, electric shaver 1 does not need to be provided with an operation mechanism for setting the load, and thus electric shaver 1 can be manufactured at a lower cost while simplifying the configuration of electric shaver 1. If electric shaver 1 is not provided with an operation mechanism for setting a load, a degree of freedom in design such as appearance of electric shaver 1 can be improved.

Electric shaver 1 may have a receiving function capable of receiving data transmitted from remote operation device 7 such as a smartphone, and a controller (controller 55, second controller 65, and the like) may change a set load based on the received data on the set load. At this time, data may be transmitted and received wirelessly or by wire.

Furthermore, in a case where blade unit 3 includes blade block 31 but does not include skin guard block 32, the control illustrated in FIG. 25 can be also performed. In this case, in step S82, sensor 53 detects a load applied to outer blade pieces 311 (that is, the outer blade).

In step S83, it is determined whether or not the load applied to any one of outer blade pieces 311 (that is, the outer blade) exceeds a predetermined average load (that is, the set load/number of blades).

In step S84, spring pedestal 512 (that is, an example of the reception part, here, a member on which the piece is supported) that supports outer blade pieces 311 (that is, the outer blade) having a load exceeding a predetermined average load (that is, the set load/number of pieces) is moved downward, and in step S85, spring pedestal 512 (that is, an example of the reception part, here, a member on which the piece is supported) is not allowed to move.

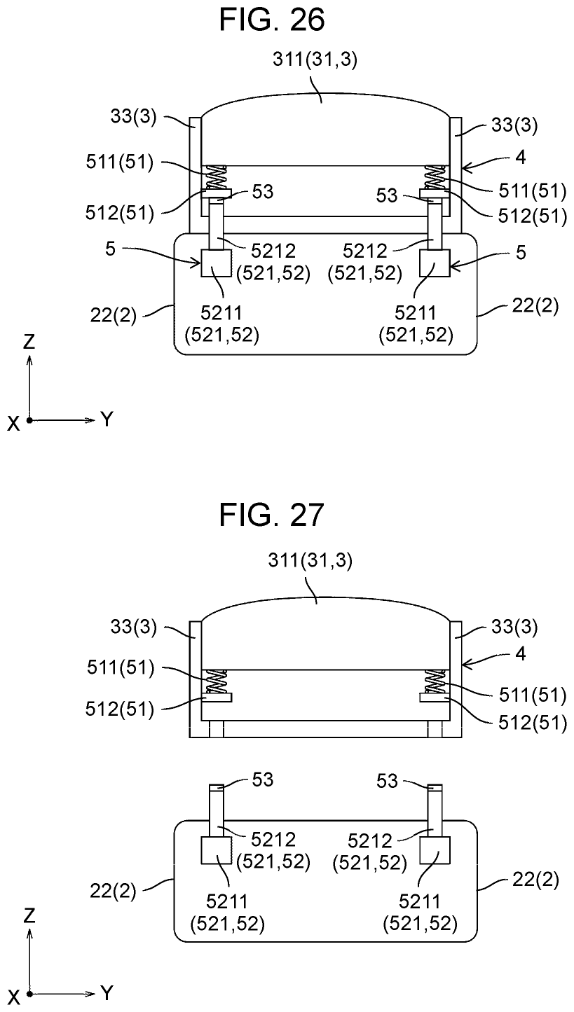

As shown in FIGS. 26 and 27, electric shaver 1 may include shaver body 2 and holding frame 33 (that is, an example of the holding member) that is detachably attached to shaver body 2 while holding outer blade pieces 311 (that is, the outer blade). In load adjustment mechanism 5, at least movable mechanism 52, sensor 53, and controller 55 may be disposed in shaver body 2. FIG. 26 is a view showing head part 22 and outer blade cassette 4 (that is, the outer blade block) included in electric shaver 1 according to a third modification, and is a front view schematically showing a state in which outer blade cassette 4 (that is, the outer blade block) is attached to head part 22. FIG. 27 is a view showing head part 22 and outer blade cassette 4 (that is, the outer blade block) included in electric shaver 1 according to the third modification, and is a front view schematically showing a state in which outer blade cassette 4 (that is, the outer blade block) is removed from head part 22.

In FIGS. 26 and 27, movable mechanism 52 of load adjustment mechanism 5 includes a slide motor 521 as a drive source. Slide motor 521 includes fixed part 5211 and movable part 5212 that extends and contracts in one direction on fixed part 5211. In a state where one direction (that is, the extending and contracting direction of movable part 5212 with respect to fixed part 5211) is vertical direction Z, fixed part 5211 is fixed to head part 22 (that is, one element of shaver body 2), and sensor 53 is fixed to the upper end of movable part 5212.

On the other hand, float mechanism 51 of load adjustment mechanism 5, that is, spring 511 (that is, an example of the biasing member) and spring pedestal 512 (that is, an example of the reception part) are attached to holding frame 33 (that is, an example of the holding member).

This simplifies the configuration of a portion (For example, outer blade cassette 4 and the like) of outer blade pieces 311 (that is, the outer blade) that can be removed from shaver body 2.

By disposing movable mechanism 52, sensor 53, and controller 55 in shaver body 2, a portion of outer blade pieces 311 (that is, the outer blade) that can be removed from shaver body 2 (For example, outer blade cassette 4 and the like) can be manufactured at a lower cost.

Accordingly, when a portion (For example, outer blade cassette 4 and the like) of outer blade pieces 311 (that is, the outer blade) that can be removed from shaver body 2 is used as a replacement blade, a more inexpensive replacement blade can be provided.

In addition, since movable mechanism 52, sensor 53, and controller 55 requiring wiring 54 are disposed in shaver body 2, holding frame 33 (that is, an example of the holding member) can be more easily attached to and detached from shaver body 2.

In FIGS. 26 and 27, spring 511 (that is, an example of the biasing member) and spring pedestal 512 (that is, an example of the reception part) are attached to holding frame 33 (that is, an example of the holding member), but spring pedestal 512 (that is, an example of the reception part) may be also disposed in shaver body 2. It is also possible to dispose spring 511 (that is, an example of the biasing member) and spring pedestal 512 (that is, an example of the reception part) in shaver body 2.

When blade unit 3 includes blade block 31 and skin guard block 32, second load adjustment mechanism 6 having the same configuration as load adjustment mechanism 5 described in FIGS. 26 and 27 and the modification thereof can be used. That is, at least second movable mechanism 62, second sensor 63, and second controller 65 of second load adjustment mechanism 6 can be arranged in shaver body 2.

### [Actions and Effects]

Hereinafter, a characteristic configuration of the outer blade block and the electric shaver described in each exemplary embodiment and the modification thereof, and an effect obtained by the characteristic configuration will be described.

### (Technology 1)

Electric shaver 1 described in the exemplary embodiment and the modifications of the exemplary embodiment includes at least one outer blade piece 311 (that is, the outer blade) and load adjustment mechanism 5 configured to adjust a load (that is, the load applied to the outer blade) applied to the at least one outer blade piece 311 (that is, the outer blade).

Load adjustment mechanism 5 includes float mechanism 51 that causes at least one outer blade piece 311 (that is, the outer blade) to float in vertical direction Z (that is, an example of the term “in one direction”). This float mechanism 51 includes spring 511 (that is, an example of the biasing member) that biases at least one outer blade piece 311 (that is, the outer blade) upward (that is, an example of “toward one side”) in vertical direction Z (that is, an example of the term “in one direction”), and spring pedestal 512 (that is, an example of the reception part) that receives spring 511 (that is, an example of the biasing member).

Load adjustment mechanism 5 further includes movable mechanism 52 configured to move spring pedestal 512 (that is, an example of the reception part) in vertical direction Z (that is, an example of the term “in one direction”), and sensor 53 that detects a load applied to at least one outer blade pieces 311 (that is, the outer blade).

Load adjustment mechanism 5 includes controller 55 that controls a movement amount of spring pedestal 512 (that is, an example of the reception part) in vertical direction Z (that is, an example of the term “in one direction”) based on a load applied to at least one outer blade pieces 311 (that is, the outer blade) detected by sensor 53.

As described above, in electric shaver 1 described in the exemplary embodiment and the modifications of the exemplary embodiment, the position of spring pedestal 512 that receives spring 511 can be controlled while at least one outer blade pieces 311 are biased upward in vertical direction Z by spring 511.

Consequently, it is possible to appropriately change a pressing force (that is, the pressing load) of at least one outer blade piece 311 to skin S with respect to a pressing amount of at least one outer blade piece 311 to skin S (that is, a downward movement amount of outer blade piece 311 from the top dead center). As a result, for example, when electric shaver 1 is used, even if at least one outer blade piece 311 is pressed against skin S too strongly, or even if the pressing force of at least one outer blade piece 311 against skin S becomes too weak, at least one outer blade piece 311 can be pressed against skin S with a more appropriate pressing force.

As described above, use of electric shaver 1 according to the exemplary embodiment and the modifications of the exemplary embodiment can suppress excessive strong pressing of at least one outer blade piece 311 against skin S, and excessive weak pressing force of outer blade piece 311 against skin S. As a result, at least one outer blade piece 311 can be pressed against skin S with a more appropriate pressing force, so that a burden on skin S can be reduced while suppressing a decrease in cutting efficiency of the whisker (that is, one example of body hair) during shaving (that is, when electric shaver 1 is in use).

In other words, controller 55 includes an electronic circuit, and during operation, the electronic circuit controls a movement amount of spring pedestal 512 (that is, an example of the reception part) in vertical direction Z (that is, an example of the term “in one direction”) based on a load applied to at least one outer blade pieces 311 (that is, the outer blade) detected by sensor 53.

Examples of the electronic circuit includes a semiconductor electric circuitry element, such as a semiconductor integrated circuit commonly referred to as “IC” or a large scale integrated circuit commonly referred to as “LSI”.

### (Technology 2)

In the above (Technology 1), electric shaver 1 may include a plurality of outer blade pieces 311 (that is, the outer blades).

This increases a contact area of outer blade pieces 311 with skin S, thereby cutting whiskers (that is, one example of body hair) more efficiently. Further, since the pressing force from skin S can be dispersed to each of outer blade pieces 311 (that is, the outer blade), it is possible to perform shaving (that is, to use electric shaver 1) while reducing the burden on skin S more reliably.

Electric shaver 1 provided with the plurality of outer blade pieces 311 can include different types of outer blade pieces 311 (that is, the outer blade). For example, electric shaver 1 can be electric shaver 1 including: at least one outer net blade piece having a function of cutting off a whisker (that is, one example of body hair) that is mainly lying down and a whisker (that is, one example of body hair) that is short and standing; and at least one outer slit blade piece having a function of cutting off mainly a thin long whisker (that is, one example of body hair). Further, the at least one outer net blade piece may include a plurality of outer net blade pieces having different curvatures of curved portions. As described above, electric shaver 1 can be formed by appropriately combining outer blade pieces having various functions. This makes it possible to more efficiently and more reliably cut off a whisker (that is, one example of body hair).

### (Technology 3)

In the above (Technology 2), at least two outer blade pieces 311 (that is, the outer blade) may be configured to be separately and independently adjustable by load adjustment mechanism 5.

This makes it possible to prevent a pressing force applied to skin S during use of electric shaver 1 from being biased to any one of outer blade pieces 311. That is, the pressing force from each outer blade piece 311 to skin S can be made a more uniform load. As a result, the burden on skin S can be more reliably reduced, and shaving can be performed (that is, electric shaver 1 is used) while reducing the burden on skin S.

### (Technology 4)

Further, in the above (Technology 3), controller 55 may control the movement amount of spring pedestal 512 (that is, an example of the reception part) in vertical direction Z (that is, an example of the term “in one direction”) so that loads applied to the plurality of outer blade pieces 311 (that is, the outer blade) become substantially the same as each other.

Accordingly, concentration of pressing force on any one of outer blade pieces 311 can be more reliably suppressed. That is, it is possible to more reliably suppress the presence of outer blade pieces 311 having an excessively strong pressing force and outer blade pieces 311 having an excessively weak pressing force during shaving (that is, when electric shaver 1 is in use). Therefore, the burden on skin S when shaving is performed (that is, when electric shaver 1 is used) can be reduced more reliably.

In addition, since all of the plurality of outer blade pieces 311 can have substantially equal pressing forces, shaving performance (that is, an example of the cutting performance) can be sufficiently exhibited in all outer blade pieces 311 during shaving (that is, when electric shaver 1 is in use). As a result, the whisker (that is, one example of body hair) can be cut more efficiently and more reliably.

### (Technology 5)

In (Technology 3) or (Technology 4) described above, controller 55 may control outer blade pieces 311 (that is, the outer blade) having a load larger than a predetermined load so that the total load applied to outer blade pieces 311 (that is, the outer blade) becomes a preset load.

This also makes it possible to more efficiently and more reliably cut off a whisker (that is, one example of body hair).

In particular, when the total load of the pressing forces (that is, the pressing load) of outer blade pieces 311 (that is, the outer blade) on skin S during shaving (that is, when electric shaver 1 is in use) is smaller than the preset load, the number of outer blade pieces 311 (that is, the outer blade) having a load larger than the target pressing force (that is, predetermined load, here, preset load/number of outer blade pieces) may be reduced.

For example, when outer blade pieces 311 (that is, the outer blade) are pressed against a recessed portion of skin S by using electric shaver 1 having five outer blade pieces 311 (that is, the outer blade), if a total load of pressing forces (that is, the pressing load) of outer blade pieces 311 (that is, the outer blade) to skin S is smaller than a preset load, outer blade pieces 311 (that is, the outer blade) having a pressing force larger than a target load (that is, a predetermined load, here, a preset load/five) may become two outer blade pieces 311 (that is, the outer blade) at both front and rear ends. In this case, the number of outer blade pieces 311 (that is, the outer blade) having the pressing force larger than the target load (here, a preset load/five) is smaller than the number of outer blade pieces 311 (that is, the outer blade) having the pressing force smaller than the target load (here, a preset load/five).

Therefore, in such a case, by controlling outer blade pieces 311 (that is, the outer blade) having a load larger than a preset load, the number of outer blade pieces 311 (that is, the outer blade) to be controlled can be reduced.

Also when electric shaver 1 includes a large number of outer blade pieces 311 (that is, the outer blade), the number of outer blade pieces 311 (that is, the outer blade) having a pressing force larger than a target load (here, a preset load/five) is often smaller than the number of outer blade pieces 311 (that is, the outer blade) having a pressing force smaller than a target load (here, a preset load/five). Therefore, by controlling outer blade pieces 311 (that is, the outer blade) having a load larger than a preset load, the number of outer blade pieces 311 (that is, the outer blade) to be controlled can be reduced.

As described above, by controlling outer blade pieces 311 (that is, the outer blade) having a load larger than the preset load so that the total load applied to outer blade pieces 311 (that is, the outer blade) becomes the preset load, shaving can be performed (that is, electric shaver 1 is used) while reducing the load on skin S by controlling smaller number of outer blade pieces 311 (that is, the outer blade).

### (Technology 6)

Furthermore, in any one of above (Technology 3) to (Technology 5), controller 55 may control the outer blade pieces 311 (that is, the outer blade) having a load smaller than a predetermined load so that the total load applied to the outer blade pieces 311 (that is, the outer blade) becomes a preset load.

This also makes it possible to more efficiently and more reliably cut off a whisker (that is, one example of body hair).

In particular, when the total load of the pressing forces (that is, the pressing load) of outer blade pieces 311 (that is, the outer blade) on skin S during shaving (that is, when electric shaver 1 is in use) is larger than the preset load, the number of outer blade pieces 311 (that is, the outer blade) having a load smaller than the target pressing force (predetermined load: preset load/number of outer blade pieces) may be reduced.

For example, when outer blade pieces 311 (that is, the outer blade) are pressed against a portion where skin S protrudes using electric shaver 1 having five outer blade pieces 311 (that is, the outer blade), if a total load of pressing forces (that is, the pressing load) of outer blade pieces 311 (that is, the outer blade) to skin S is larger than a preset load, outer blade pieces 311 (that is, the outer blade) having a pressing force smaller than a target load (that is, a predetermined load, here, a preset load/five) may become two outer blade pieces 311 (that is, the outer blade) at both front and rear ends. In this case, the number of outer blade pieces 311 (that is, the outer blade) having the pressing force smaller than the target load (here, a preset load/five) is smaller than the number of outer blade pieces 311 (that is, the outer blade) having the pressing force larger than the target load (here, a preset load/five).

Therefore, in such a case, by controlling outer blade pieces 311 (that is, the outer blade) having a load smaller than a preset load, the number of outer blade pieces 311 (that is, the outer blade) to be controlled can be reduced.

Also when the number of outer blade pieces 311 (that is, the outer blade) included in electric shaver 1 is small, the number of outer blade pieces 311 (that is, the outer blade) with the pressing force smaller than the target load (here, a preset load/five) is often smaller than the number of outer blade pieces 311 (that is, the outer blade) having the pressing force larger than the target load (here, a preset load/five). Therefore, by controlling outer blade pieces 311 (that is, the outer blade) having a load smaller than a preset load, the number of outer blade pieces 311 (that is, the outer blade) to be controlled can be reduced.

Thus, by controlling outer blade pieces 311 (that is, the outer blade) having a load smaller than the preset load so that the total load applied to outer blade pieces 311 (that is, the outer blade) becomes the preset load, shaving can be performed (that is, electric shaver 1 is used) while reducing the load on skin S by controlling smaller number of outer blade pieces 311 (that is, the outer blade).

By combining (Technology 5) and (Technology 6), when the number of outer blade pieces 311 (that is, the outer blade) having the pressing force larger than the target load (here, a preset load/five) is small, the outer blade pieces 311 (that is, the outer blade) having the pressing force larger than the target load (here, a preset load/five) can be controlled, and when the number of outer blade pieces 311 (that is, the outer blade) having the pressing force larger than the target load (here, a preset load/five) is large, the outer blade pieces 311 (that is, the outer blade) having the pressing force smaller than the target load (here, a preset load/five) can be also controlled. In this way, the number of outer blade pieces 311 (that is, the outer blade) to be more reliably controlled can be reduced.

### (Technology 7)

In any one of above (Technology 1) to (Technology 6), controller 55 may control outer blade pieces 311 (that is, the outer blade) so that a load applied to outer blade pieces 311 (that is, the outer blade) becomes a preset set load. Electric shaver 1 may be configured to change a set load.

In this way, it is possible for each user to set a load (that is, a load suitable for the strength of the skin of the user) according to each skin strength and preference, and it is possible to provide a personalizable product (For example, electric shaver 1).

In the case that the same user uses a product, the setting can be changed according to the tone of skin S during use, so that the product (For example, electric shaver 1) configured to respond to the daily changing state of skin S of the user can be provided.

### (Technology 8)

In the above (Technology 7), electric shaver 1 may be configured to remotely change the preset set load.

In this way, the load can be set using remote operation device 7 such as a smartphone. As a result, electric shaver 1 does not need to be provided with an operation mechanism for setting a load, so that electric shaver 1 can be manufactured at a lower cost while the configuration of electric shaver 1 is simplified. Further, if the operation mechanism for setting a load is not provided in electric shaver 1, the degree of freedom of design such as appearance of electric shaver 1 can be also improved.

### (Technology 9)

In any one of above (Technology 1) to (Technology 8), electric shaver 1 may include shaver body 2 and holding frame 33 (that is, an example of the holding member) that is detachably attached to shaver body 2 while holding at least one outer blade piece 311 (that is, the outer blade). In load adjustment mechanism 5, at least movable mechanism 52, sensor 53, and controller 55 may be disposed in shaver body 2.

This can simplify the configuration of a portion (For example, outer blade cassette 4 and the like) of at least one outer blade piece 311 (that is, the outer blade) that can be removed from shaver body 2. By disposing movable mechanism 52, sensor 53, and controller 55 in shaver body 2, a portion of at least one outer blade piece 311 (that is, the outer blade) that can be removed from shaver body 2 (For example, outer blade cassette 4 and the like) can be manufactured at a lower cost. Accordingly, when a portion of at least one outer blade piece 311 (that is, the outer blade) that can be removed from shaver body 2 (For example, outer blade cassette 4 and the like) is used as a replacement blade, a more inexpensive replacement blade can be provided.

In addition, since movable mechanism 52, sensor 53, and controller 55 requiring wiring 54 are disposed in shaver body 2, holding frame 33 (that is, an example of the holding member) can be more easily attached to and detached from shaver body 2.

### (Technology 10)

In any one of above (Technology 1) to (Technology 9), electric shaver 1 may include skin guard pieces 321 (that is, an example of the skin guard part) and second load adjustment mechanism 6 configured to adjust the load applied to skin guard pieces 321 (that is, an example of skin guard part). In addition, second load adjustment mechanism 6 may include second float mechanism 61 that floats skin guard pieces 321 (that is, an example of the skin guard part) in vertical direction Z (that is, an example of the term “in one direction”). At this time, second float mechanism 61 may include second spring 611 (that is, an example of the second biasing member) that biases skin guard pieces 321 (that is, an example of the skin guard part) to the upper side (that is, an example of “toward one side”) in vertical direction Z (that is, an example of the term “in one direction”). Further, second float mechanism 61 may have second spring pedestal 612 (that is, an example of the second reception part) that receives second spring 611 (that is, an example of the second biasing member). In addition, second load adjustment mechanism 6 may include second movable mechanism 62 configured to move second spring pedestal 612 (that is, an example of the second reception part) in vertical direction Z (that is, an example of the term “in one direction”), and second sensor 63 that detects the load applied to skin guard pieces 321 (that is, an example of the skin guard part). Second load adjustment mechanism 6 may include second controller 65 that controls the movement amount of second spring pedestal 612 (that is, an example of the second reception part) in vertical direction Z (that is, an example of the term “in one direction”) based on the load applied to skin guard pieces 321 (that is, an example of the skin guard part) detected by second sensor 63.

Thus, the pressing force from skin S can also be dispersed to skin guard pieces 321 (that is, an example of the skin guard part), so that the load applied to one outer blade piece 311 (that is, the outer blade) can be further reduced. As a result, shaving can be performed (that is, electric shaver 1 is used) while reducing the burden on skin S more reliably.

### (Technology 11)

In above (Technology 10), second controller 65 may control the movement amount of second spring pedestal 612 (that is, an example of the second reception part) in vertical direction Z (that is, an example of the term “in one direction”) so that the load applied to skin guard pieces 321 (that is, an example of the skin guard part) and the load applied to outer blade pieces 311 (that is, the outer blade) are different.

This also makes it possible to perform shaving (that is, to use electric shaver 1) while reducing the burden on skin S more reliably.

At this time, if the load applied to skin guard pieces 321 (that is, an example of the skin guard part) is made larger than the load applied to outer blade pieces 311 (that is, the outer blade), the load per one outer blade piece 311 (that is, the outer blade) can be further reduced. Therefore, shaving can be performed (that is, electric shaver 1 is used) while reducing the burden on skin S more reliably.

On the other hand, if the load applied to skin guard pieces 321 (that is, an example of the skin guard part) is made smaller than the load applied to outer blade pieces 311 (that is, the outer blade), the load per one outer blade piece 311 (that is, the outer blade) can be increased. As a result, the adhesion of outer blade pieces 311 (that is, the outer blade) to skin S is enhanced, and shaving can be performed (that is, electric shaver 1 is used) while performing deeper shaving.

### (Technology 12)

Further, in the above (Technology 10), second controller 65 may control the movement amount of second spring pedestal 612 (that is, an example of the second reception part) in vertical direction Z (that is, an example of the term “in one direction”) such that the load applied to the skin guard pieces (skin guard part) and the load applied to outer blade pieces 311 (that is, the outer blade) become substantially the same as each other.

This also makes it possible to perform shaving (that is, to use electric shaver 1) while reducing the burden on skin S more reliably.

If the load applied to skin guard pieces 321 (that is, an example of the skin guard part) and the load applied to outer blade pieces 311 (that is, the outer blade) are made substantially equal, each piece (that is, outer blade piece 311 and skin guard piece 321) is more evenly pressed against skin S, so that the skin contact can be improved when shaving is performed (that is, electric shaver 1 is used).

### (Technology 13)

Outer blade cassette 4 (that is, the outer blade block) described in the exemplary embodiment and the modifications of the exemplary embodiment can be used in electric shaver 1 described in any one of above (Technology 1) to (Technology 12). Outer blade cassette 4 (that is, the outer blade block) includes outer blade pieces 311 (that is, the outer blade), and holding frame 33 (that is, an example of the holding member) detachably attached to shaver body 2 in a state of holding outer blade pieces 311 (that is, the outer blade). When holding frame 33 (that is, an example of the holding member) is attached to shaver body 2 while holding outer blade pieces 311 (that is, the outer blade), a load applied to outer blade pieces 311 (that is, the outer blade) can be adjusted by load adjustment mechanism 5.

Consequently, it is possible to obtain outer blade cassette 4 (that is, the outer blade block) configured to press outer blade pieces 311 (that is, the outer blade) against skin S with a more appropriate pressing force. Also when outer blade cassette 4 (that is, the outer blade block) detachably attached to shaver body 2 is used, outer blade pieces 311 can be pressed against skin S with a more appropriate pressing force.

### [Others]

Although the contents of the slit blade block and the electric shaver according to the present disclosure have been described above, the present disclosure is not limited to these descriptions, and it is obvious to those skilled in the art that various modifications and improvements can be made.

For example, the present disclosure can be applied to exemplary embodiments in which changes, replacements, additions, omissions, and the like of the configurations described in the exemplary embodiments and the modifications thereof are made. In addition, it is also possible to make a new exemplary embodiment by combining the constituent elements described in the exemplary embodiment and the modifications thereof.

In the exemplary embodiment and the modifications of the exemplary embodiment, electric shaver 1 including grip part 21 and head part 22 is exemplified. However, the present disclosure is also applicable to an electric shaver provided with no head part.

In the exemplary embodiment and the modifications of the exemplary embodiment, all of the plurality of blade blocks 31 are held by head part 22 (that is, one element of shaver body 2) in a floatable manner. However, some of blade blocks 31 may be held by head part 22 (that is, one element of shaver body 2) in a non-floatable state.

In the exemplary embodiment and the modifications of the exemplary embodiment, blade unit 3 includes the plurality of blade blocks 31. However, blade unit 3 may include only one blade block 31.

In the exemplary embodiment and the modifications of the exemplary embodiment, all of the plurality of pieces (that is, outer blade pieces 311 and skin guard pieces 321) are separately and independently controllable. Alternatively, at least two pieces may be controlled in conjunction with each other. In this case, when electric shaver 1 is in use, it is preferable to interlock pieces of electric shaver 1 with which a difference in pressing force is not so large.

When at least two pieces are interlocked, the respective reception parts may be controlled to be interlocked in a state of being received by separate reception parts (For example, spring pedestal 512 and second spring pedestal 612).

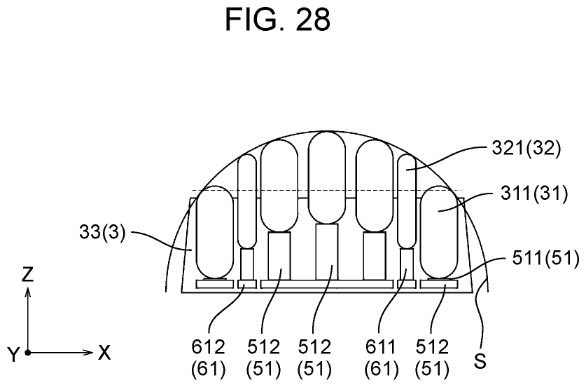

When at least two pieces are interlocked, as illustrated in FIG. 28, one reception part can receive a plurality of pieces, and one reception part can be moved to control at least two pieces to be interlocked. FIG. 28 is a side view schematically showing outer blade cassette 4 (that is, the outer blade block) included in electric shaver 1 according to a fourth modification. In FIG. 28, one spring pedestal 512 (that is, an example of the reception part) supports three outer blade pieces 311 (that is, the outer blade) at the center. However, the present invention is not limited to such a configuration, and various configurations can be adopted. For example, two adjacent outer blade pieces 311 (that is, the outer blade) can be supported by one spring pedestal 512 (that is, an example of the reception part), or adjacent outer blade pieces 311 and skin guard pieces 321 can be supported by one spring pedestal (that is, an example of the reception part).

As described above, when the plurality of pieces are received by one reception part, the number of reception parts is reduced, so that the cost can be reduced while simplifying the configuration. When at least two pieces are controlled to be interlocked, there is also an advantage that the control signal can be reduced.

In addition, in the above-described exemplary embodiment and the modifications thereof, all of the plurality of pieces (that is, outer blade pieces 311 and skin guard pieces 321) can be controlled separately and independently, but at least two pieces can also be controlled separately and independently.

The arrangement order of the plurality of blade blocks 31 and the plurality of skin guard blocks 32 can also be appropriately set.

In the exemplary embodiment and the modifications of the exemplary embodiment, by way of example, the reciprocating electric shaver that reciprocates inner blades 312 with respect to outer blade pieces 311 has been described. However, the present disclosure is also applicable to a rotary electric shaver that rotates inner blades 312 with respect to outer blade pieces 311.

The specifications (For example, shape, size, layout, and the like) of the head part, the shaver body, and other details can also be changed as appropriate.

As described above, the outer blade block and the electric shaver according to the present disclosure are configured to press the outer blade against the skin with a more appropriate pressing force. Accordingly, the outer blade block and the electric shaver according to the present disclosure are applicable not only to whiskers but also to various hair treatments.

What is claimed is:

1. An electric shaver, comprising:
at least one outer blade; and
a load adjustment mechanism configured to adjust a load applied to the at least one outer blade,
wherein
the load adjustment mechanism comprises:
a float mechanism that comprises a biasing member that biases the at least one outer blade toward one side in one direction, and a reception part that receives the biasing member, and floats the at least one outer blade in the one direction;
a movable mechanism configured to move the reception part in the one direction;
a sensor that detects the load applied to the at least one outer blade; and
a controller that controls a movement amount of the reception part in the one direction based on the load applied to the at least one outer blade detected by the sensor.

2. The electric shaver according to claim 1, wherein
the at least one outer blade includes a plurality of outer blades.

3. The electric shaver according to claim 2, wherein
at least two outer blades selected from the plurality of the outer blades are configured to be separately and independently adjustable by the load adjustment mechanism.

4. The electric shaver according to claim 3, wherein
the controller controls a movement amount of the reception part in the one direction so that loads applied to the plurality of the outer blades are substantially the same as each other.

5. The electric shaver according to claim 3, wherein
the controller controls the at least one outer blade having a load larger than a predetermined load so that a total of loads applied to the plurality of the outer blades becomes a preset load.

6. The electric shaver according to claim 3, wherein
the controller controls the at least one outer blade having a load smaller than a predetermined load so that a total of loads applied to the plurality of the outer blades becomes a preset load.

7. The electric shaver according to claim 1, wherein
the controller controls the at least one outer blade so that the load applied to the at least one outer blade becomes a preset set load, and is configured to change the set load.

8. The electric shaver according to claim 7, wherein
the electric shaver is configured to change the preset set load remotely.

9. The electric shaver according to claim 1, further comprising:
a shaver body; and
a holding member detachably attached to the shaver body in a state of holding the at least one outer blade,
wherein
the movable mechanism, the sensor, and the controller of the load adjustment mechanism are disposed in the shaver body.

10. The electric shaver according to claim 1, further comprising:
a skin guard part; and
a second load adjustment mechanism configured to adjust a load applied to the skin guard part,
wherein
the second load adjustment mechanism comprises:
a second float mechanism that comprises a second biasing member that biases the skin guard part toward one side in one direction and a second reception part that receives the second biasing member, and floats the skin guard part in the one direction;
a second movable mechanism configured to move the second reception part in the one direction;
a second sensor that detects the load applied to the skin guard part; and
a second controller that controls a movement amount of the second reception part in the one direction based on the load applied to the skin guard part detected by the second sensor.

11. The electric shaver according to claim 10, wherein
the second controller controls a movement amount of the second reception part in the one direction so that the load applied to the skin guard part is different from the load applied to the at least one outer blade.

12. The electric shaver according to claim 10, wherein
the second controller controls a movement amount of the second reception part in the one direction so that the load applied to the skin guard part and the load applied to the at least one outer blade are substantially the same as each other.

13. An outer blade block usable in the electric shaver according to claim 1, the outer blade block comprising:
an outer blade; and
a holding member detachably attached to a shaver body in a state of holding the at least one outer blade,
wherein the load applied to the outer blade is configured to be adjusted by the load adjustment mechanism when the holding member is attached to the shaver body in a state where the outer blade is held.
